(19) United States
(12) Patent Application Publication
(10) Pub. No.: US 2012/0233778 A1
(43) Pub. Date: Sep. 20, 2012

(54) Blanket with Multiple Panels and Methods of Manufacturing Same

(76) Inventors: James Troy Shull, Plano, TX (US); Matthew Curry Shull, Naperville, IL (US)

(21) Appl. No.: 13/048,494

(22) Filed: Mar. 15, 2011

(51) Int. Cl. A47G 9/02; B23P 11/00

(52) U.S. Cl. 5/502; 29/428

(57) ABSTRACT

Disclosed are multiple panel blankets, and related methods of construction, that allow the use of just one blanket that has multiple panels attached together, one or more of which may be removed for various applications. The user can place an infant/baby on a base panel and then cover it with the other panels attached to the base panel. Likewise, the parent could use all the panels. In one embodiment, a multiple paneled blanket may comprise a base panel and at least one upper panel located on the base panel. The at least one upper panel has at least one of a length or a width coextensive with a corresponding length or width of the base panel. The at least one upper panel is fastened to the base panel along at least a portion of corresponding sides of the base panel and the at least one upper panel that provide the coextensive length or width.

### TECHNICAL FIELD

The present disclosure relates generally to blankets, and more specifically to multiple panel blankets, with varying methods of attachment, for use by all ages for a variety of applications.

### BACKGROUND

Blankets are used by infants, babies, and toddlers for a variety of reasons such as warmth, comfort, and protection. For example, parents often cover up their infants/babies to keep them warm since they can have difficulties in regulating their own body temperatures. Additionally, for a toddler, the blanket can be used to play on or for carrying around. Moreover, blankets may also be used by people of all ages, not only young children, in a variety of applications in additional to keeping warm.

Structurally, the blankets are typically comprised of a variety of materials. Such materials can by either natural or synthetic, or perhaps even a combination of both types of materials. Exemplary natural fibers may include cotton, bamboo, wool, and cashmere), while exemplary synthetic materials may include polyester, microfiber, acrylic, and fleece. Each material has different properties depending on its intended use, and each material also has its own advantages and disadvantages. Examples of advantages can be materials that have one or more characteristics such as being lightweight, highly insulating, soft/comfortable, and/or inexpensive. Examples of disadvantages in certain materials can be that they are too insulating for all uses, they can be uncomfortable to the touch although highly insulating, or perhaps certain blankets are simply too expensive to use as a blanket in applications that have the blanket touching the ground or even the user's own skin. Accordingly, what is needed in the art is a blanket adaptable for use by multiple ages, for a variety of applications, and that can incorporate the advantages of a variety of different blankets/materials, while simultaneously reducing or eliminating disadvantages associated with certain blanket materials, particularly during certain applications.

### SUMMARY

Rather than using multiple, single blankets, the principles of the present disclosure allow the use of just one blanket that has multiple panels attached together, one or more of which may be removed for various blanket applications depending on the method of attachment. With multiple panels, the user, for example a parent, can place an infant/baby on a base panel and then cover him or her with the other panels attached to the base panel. Likewise, the parent could choose all panels to cover the baby. The parent may also choose to place the baby on the base layer and then swaddle him or her with one of the other attached panels. Furthermore, if the disclosed multiple panel blanket is used with a mattress or on another soft surface, all of the attached panels on the disclosed blanket may be used to cover the user. In other uses, for example for a toddler, the parent could allow him or her to use the base layer as a play mat. Since the multiple panels are detachable, the parent could remove the panels so that the toddler may carry his or her favorite panel separate from the other panels of the disclosed blanket.

In sum, a multiple paneled blanket is more flexible than a traditional blanket, and far more convenient than carrying multiple distinct blankets in preparation for all potential uses. Moreover, parents no longer need to buy several blankets, and can instead just buy one of the disclosed multiple paneled blankets which allows a user to easily add and remove layers for their infant, baby, or toddler, or even simply for use by an adult.

In one aspect, a multiple paneled blanket is disclosed herein. In one embodiment, such a blanket may comprise a base panel and at least one upper panel located on the base panel. The at least one upper panel has at least one of a length or a width coextensive with a corresponding length or width of the base panel. The at least one upper panel is fastened to the base panel along at least a portion of corresponding sides of the base panel and the at least one upper panel that provide the coextensive length or width.

In another embodiment, an exemplary multiple panel blanket may be comprised of a base panel and two or more upper panels stacked on the base panel. In such embodiments, at least one of a length or a width of one of the two or more upper panels is coextensive with a corresponding length or width of others of the two or more upper panels. Also, the base panel has at least one of a length or width coextensive with the corresponding coextensive length or width of the upper panels. Furthermore, the two or more upper panels are fastened to the base panel along at least a portion of corresponding sides of the base panel and the two or more upper panels that provide the coextensive length or width.

In another aspect, methods for manufacturing a multiple blanket are disclosed. In one embodiment, such a method may include providing a base panel, and then locating at least one upper panel on the base panel. In such embodiments, the at least one upper panel may have at least one of a length or a width coextensive with a corresponding length or width of the base panel. Additionally, such an exemplary method may include fastening the at least one upper panel to the base panel along at least a portion of corresponding sides of the base panel and the at least one upper panel that provide the coextensive length or width.

### BRIEF DESCRIPTION OF THE DRAWINGS

FIG. 1 illustrates one embodiment of a blanket according to the disclosed principles, which is comprised of three panels, each with different dimensions;

FIGS. 2a, 2b, 2c, and 2d illustrate the three panels of the blanket illustrated in FIG. 1, which are attached along one edge to form a blanket constructed according to the disclosed principles;

FIG. 3 illustrates another embodiment of a blanket, which is comprised of three panels each having the same dimensions;

FIGS. 4a, 4b, 4c, and 4d illustrate the three panels of the blanket illustrated in FIG. 3, which are attached along one side to form a blanket constructed according to the disclosed principles;

FIGS. 4e and 4f illustrate the three panels of the blanket illustrated in FIG. 3, but which are attached along multiple sides to form a blanket constructed according to the disclosed principles;

FIGS. 4g and 4h illustrate the three panels of the blanket illustrated in FIG. 3, but which are attached along multiple sides of one panel and one side of the other panels to form a blanket constructed according to the disclosed principles;

FIG. 5 illustrates another embodiment of a blanket constructed according to the disclosed principles, which is comprised of three panels each having different dimensions;

FIGS. 6a, 6b, 6c, and 6d illustrate the three panels of the blanket illustrated in FIG. 5, which are attached along one side to form a blanket constructed according to the disclosed principles;

FIGS. 6e and 6f illustrate the three panels of the blanket illustrated in FIG. 5, but which are now attached along multiple sides to form a blanket constructed according to the disclosed principles;

FIGS. 6g and 6h illustrate the three panels of the blanket illustrated in FIG. 5, but which are attached along multiple sides of one panel and one side of the other panels to form a blanket constructed according to the disclosed principles;

FIG. 7 illustrates yet another embodiment of a blanket constructed according to the disclosed principles and which is comprised of three panels, wherein two panels have the same dimensions but a third panel has a different dimension;

FIGS. 8a, 8b, 8c, and 8d illustrate the three panels of the blanket illustrated in FIG. 7, which are attached along one side to form a blanket constructed according to the disclosed principles;

FIGS. 8e and 8f illustrate the three panels of the blanket illustrated in FIG. 7, but which are now attached along multiple sides to form a blanket constructed according to the disclosed principles;

FIGS. 8g and 8h illustrate the three panels of the blanket illustrated in FIG. 7, but which are attached along multiple sides of one panel and one side of the other panels to form a blanket constructed according to the disclosed principles;

FIG. 9 illustrates another embodiment of a blanket constructed according to the disclosed principles, which is comprised of three panels, each with different dimensions;

FIGS. 10a, 10b, 10c, and 10d illustrate the three panels of the blanket illustrated in FIG. 9, which are attached along one side to form a blanket constructed according to the disclosed principles;

FIGS. 10e and 10f illustrate the three panels of the blanket illustrated in FIG. 9, but which are now attached along multiple sides to form a blanket constructed according to the disclosed principles;

FIGS. 10g and 10h illustrate the three panels of the blanket illustrated in FIG. 9, but which are attached along multiple sides of one panel and one side of the other panels to form a blanket constructed according to the disclosed principles; and

FIG. 11 illustrates a cross section of the multiple panels of any of the blankets illustrated in FIG. 1, 3, 5, 7 or 9.

### DETAILED DESCRIPTION

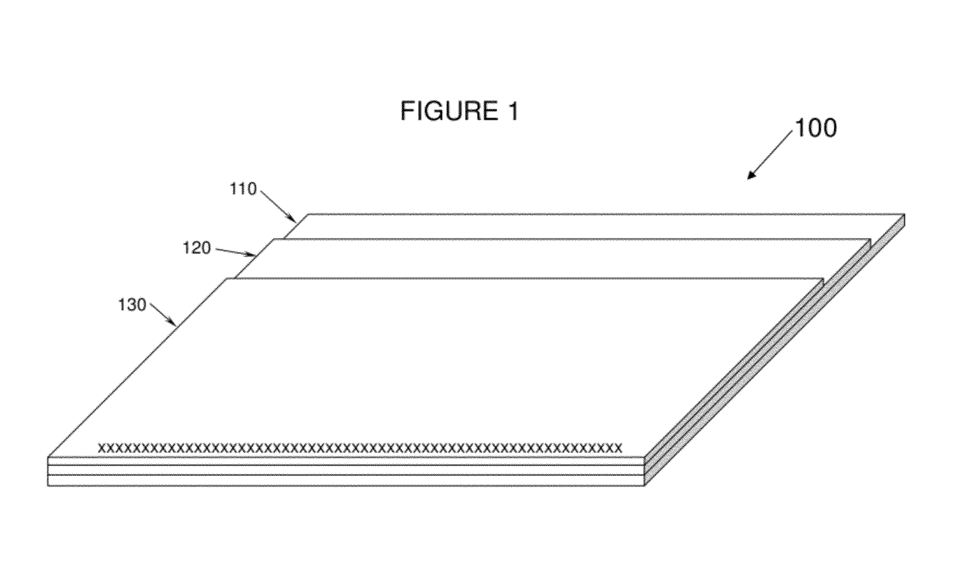

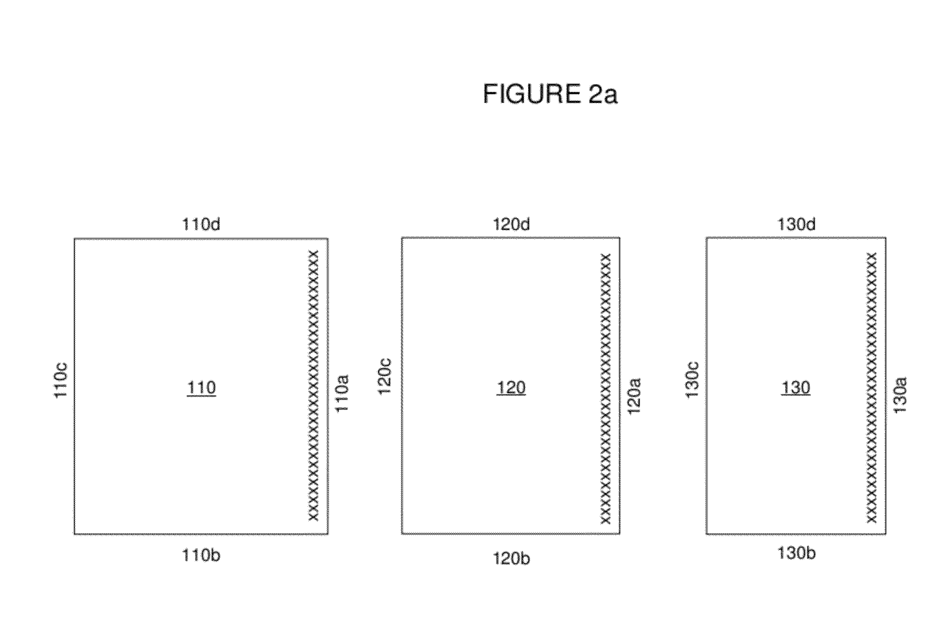

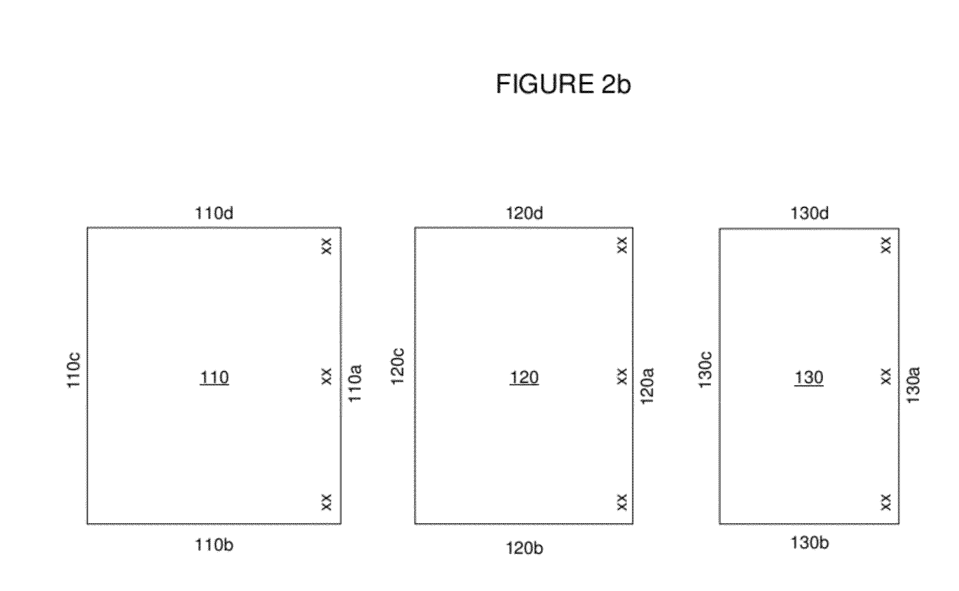

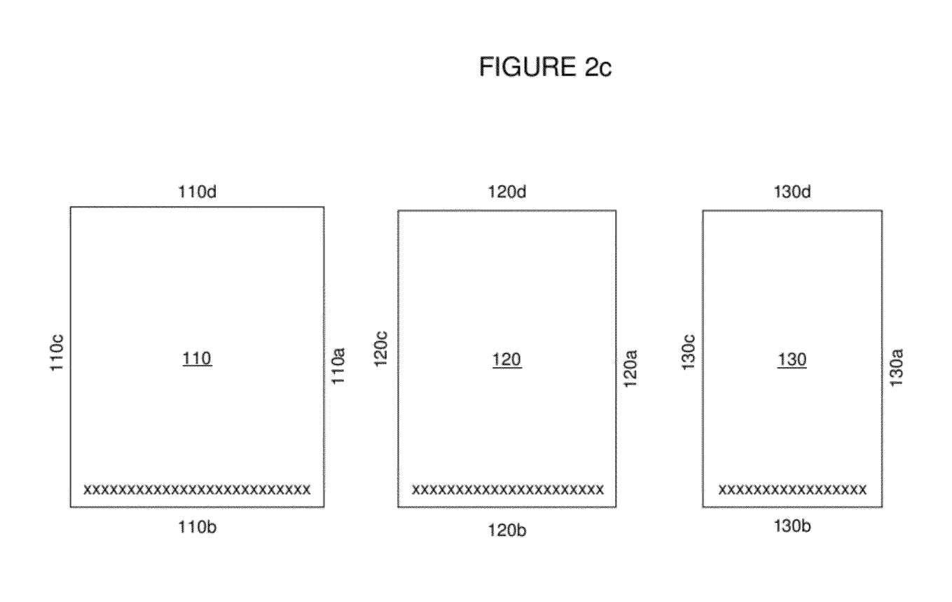

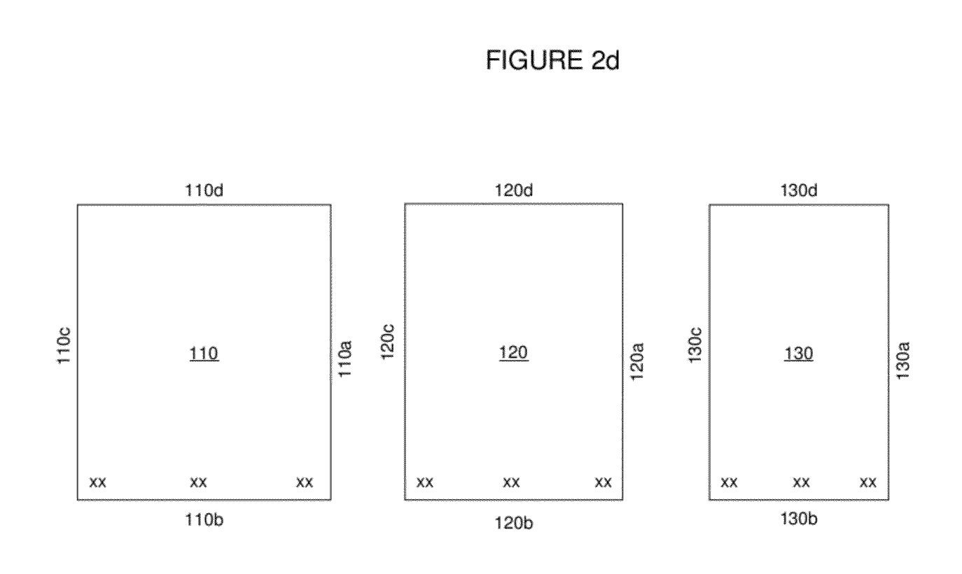

FIG. 1 illustrates an exemplary embodiment for a blanket 100 constructed according to the disclosed principles. Illustrated items of the blanket 100 in FIG. 1 include, in this embodiment, three different panel layers one over another: Panel 110, Panel 120 and Panel 130. Blanket 100 is comprised of panels 110, 120, 130, each of which have different dimensions along their widths, but have substantially the same dimensions along their lengths, as illustrated in FIG. 1. In addition, in this embodiment, panel 110 has four sides (110a, 110b, 110c and 110d), panel 120 has four sides (120a, 120b, 120c and 120d), and panel 130 has four sides (130a, 130b, 130c and 130d). In this embodiment of a blanket constructed as disclosed herein, the attachment area is provided along one of the sides of the blanket 100. In such a case, the panels 110, 120, 130 of blanket 100 may therefore be opened much like a book. FIG. 2a illustrates such an attachment area substantially along all of sides 110a, 120a and 130a of panels 110, 120, 130, respectively. FIG. 2b again illustrates the attachment area of blanket 100 along sides 110a, 120a and 130a of panels 110, 120, 130, respectively, but in this embodiment the attachment means is provided only in the middle and at the ends of these sides 110a, 120a and 130a. However, in FIG. 2c, the attachment area is provided substantially along all of the bottom edges of sides 110b, 120b and 130b of panels 110, 120, 130, respectively. FIG. 2d also illustrates the attachment area of blanket 100 along the bottom edges of sides 110b, 120b and 130b of panels 110, 120, 130, respectively, but in this embodiment the attachment means is provided only in the middle and at the ends of these bottom sides 110b, 120b and 130b of blanket 100.

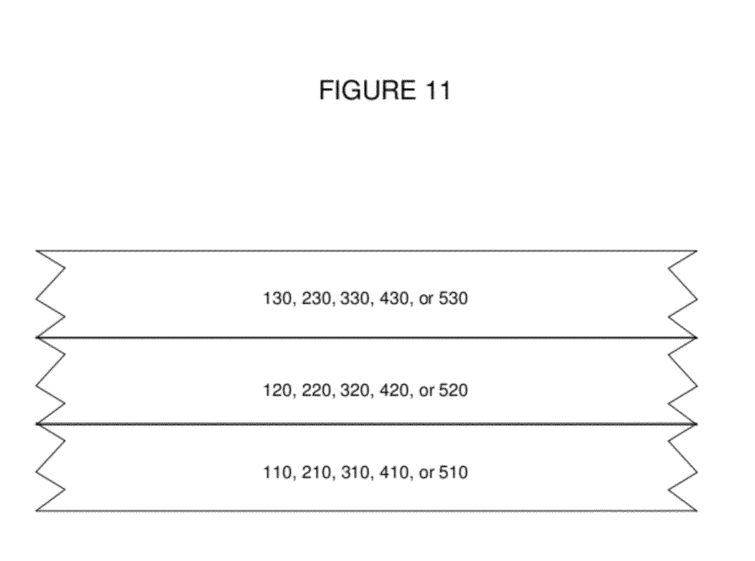

Each of the panels 110, 120, 130 having four sides is merely illustrative, and thus panels have any number of sides, or no sides per se such as with round- or elliptical-shaped blankets, are also envisioned and fall within the scope of the present disclosure. FIG. 11 illustrates one possible cross section for blanket 100.

FIGS. 2a, 2b, 2c, and 2d illustrate the individual panels 110, 120, 130 and exemplary areas of attachment along certain sides of each panel. FIGS. 2e and 2f illustrate the individual panels and areas of attachment along multiple sides of the panels illustrated therein. The “Xs” represent the area(s) of attachment. The area of attachment may be on the top, the bottom, or top and bottom of the panel, as determined by the designer or manufacturer. In addition, the attachment of panels together to form the complete blanket may be a combination of these, such as along the bottom edges of the panels, and then partially or completely up the sides of the panels.

In FIGS. 2a and 2b, a user's legs/feet could be substantially towards sides 110b, 120b, and 130b with the user's head at 110d, 120d, and 130d with the user's side substantially parallel to the area of attachment. If the user preferred not to be in contact with another surface such as the carpet or ground, the user could lie on the panel 110 and cover himself or herself with panels 120 and 130 or any combination thereof. Alternatively, the user may want to cover himself or herself with panels 110, 120, and 130 or any combination thereof if lying on a bed, couch, or another surface preferred by the user. For a baby or toddler, the parent or caretaker may prefer to place the baby or toddler on panel 110 regardless of the surface (e.g., couch, bed, carpet, or ground). The embodiment in FIG. 2a may provide more insulation and protection to the user than the embodiment in FIG. 2b since there is more area of attachment in former as compared to the latter. Alternatively, a user's feet could be substantially towards sides 110d, 120d, and 130d with the user's head at 110b, 120b, and 130b, with the user's side substantially parallel to the area of attachment. Since the panels open like a book, this embodiment allows the user to place his or her head towards sides 110b, 120b, 130b or 110d, 120d, and 130d. In FIGS. 2c and 2d, a user's feet could be substantially towards sides 110b, 120b, and 130b with the user's head at 110d, 120d, and 130d. In this case, the user could lie on panel 110 and cover himself or herself with panels 120 and 130 or any combination thereof. Alternatively, the user may want to cover himself or herself with panels 110, 120, and 130 or any combination thereof. The embodiment in FIG. 2c may provide more insulation and protection to the user than the embodiment in FIG. 2d since there is more area of attachment in the former as compared to the latter, and thus less likely hood for cold air to find its way under the blanket panel(s) through the sides having attachment means.

The embodiments in FIGS. 2a and 2b could allow the user to extend his or her feet beyond edges 110b, 120b, and 130b or edges 110d, 120d, and 130d since there is no attachment means along these sides or edges. This would be a personal preference of the user. Since the embodiments in FIGS. 2c and 2d have attachment means along sides 110b, 120b, and 130b, the user may prefer to have his or her feet covered by one or more of the panels.

The method of attachment could be, but is not limited to, stitching, zippers, snaps, hook-and-loop fasteners (e.g., Velcro®), loops of material, buttons, or ties. The designer or manufacturer may also decide to use several methods of attachment, such as buttons on Panel 110, snaps on Panel 120, and Velcro® on Panel 130, or any variations or combinations thereof.

In embodiments in which buttons are used to fasten the panels illustrated in FIG. 1, each of the panels may be comprised as follows:
Panel 110 top side: buttons along the attachment edge. The buttons may be inserted through the button hole of Panel 120 and the button hole of Panel 130 and be visible on the top side of Panel 130.
Panel 110 bottom side: buttons may be included for aesthetics only, though not required.
Panel 120: button holes passing completely through Panel 120. (Optionally, buttons could be added along the attachment edge in addition to the button holes. The buttons of Panel 120 may be inserted through the button hole of Panel 130 such that the buttons of Panel 120 would be visible on the top side of Panel 130.)
Panel 130: button holes passing completely through Panel 130.
   The time to fasten or unfasten the various panels will depend on the user and the number of buttons on each panel. Buttons may also need to be re-attached since they could become loose, fall off, or are physically removed by a user, such as by a baby or toddler. Plus, more buttons per panel could make the blanket more expensive to manufacture. The manufacturer may not want to use buttons if the blanket is intended to be used by a baby or toddler since the buttons could become detached and present a possible choking hazard to the baby or toddler. Of course, the above description of the embodiment illustrated in FIG. 1 is illustrative only, and variations to the above-described approach may also be included in a blanket constructed according to the disclosed principles.

In embodiments in which hook-and-loop fasteners (e.g., Velcro®) are used to fasten the panels illustrated in FIG. 1, each of the panels may be comprised as follows:
Panel 110 top side: hook-and-loop material.
Panel 110 bottom side: hook-and-loop material may be included for aesthetics only, though not required.
Panel 120 top side: hook-and-loop material along the attachment edge.
Panel 120 bottom side: hook-and-loop material.
Panel 130 top side: nothing along the attachment edge.
Panel 130 bottom side: hook-and-loop material along the attachment edge.
   Velcro® may be less likely to detach from one of the panels as opposed to buttons. Plus, it could be faster and easier for a user to attach or detach panels that use Velcro® as opposed to buttons. Furthermore, if the user has trouble using buttons, Velcro® may be a viable alternative. However, Velcro® may adhere to other fabrics, which could be undesirable by the user and may damage the other fabrics. In addition, the above description of the embodiment illustrated in FIG. 1 is illustrative only, and variations to the above-described approach may also be included in a blanket constructed according to the disclosed principles.

In embodiments in which zippers are used to fasten the panels illustrated in FIG. 1, each of the panels may be comprised as follows:
A single zipper connecting all three Panels 110, 120, 130 together along an attachment edge or side of each; or
A first zipper connecting all Panels 110 and 120 together along their attachment edges, and a second zipper connecting all Panels 120 and 130 together along an attachment edge or side of each.
   As a method of attachment, a zipper could be a faster means of adding and removing panels as opposed to other methods such as buttons or snaps. However, a user may need to take special care when using a zipper so that the material of the panel does not get caught in the zipper. Additionally, as before, the above description of the embodiment illustrated in FIG. 1 is illustrative only, and variations to the above-described approach may also be included in a blanket constructed according to the disclosed principles.

In embodiments in which stitching is used and the intention is not to be able to remove individual panels, all three Panels 110, 120, 130 are stitched together and would not be removably fastened together. Stitching could be an inexpensive method of attaching the panels with compared to other methods disclosed herein since the manufacturer does not have the added expense of material (e.g., buttons, zippers, Velcro, snaps) and labor and skill required to attach said material.

In embodiments in which snaps are used to fasten the panels illustrated in FIG. 1 (where each snap has a male and female part), each of the panels may be comprised as follows:
Panel 110 top side: male snaps along the attachment edge.
Panel 110 bottom side: female or male snaps may be included for aesthetics only, though not required.
Panel 120 top side: male snaps along the attachment edge.
Panel 120 bottom side: female snaps along the attachment edge.
Panel 130 top side: female or male snaps may be included for aesthetics only, though not required.
Panel 130 bottom side: female snaps along the attachment edge.
   Like buttons, the time to fasten or unfasten the various panels will depend on the user and the number of snaps on each panel. Snaps may also need to be re-attached since they could become loose, fall off, or are physically removed by a user such as a baby or toddler. Plus, more snaps per panel could make the blanket more expensive to manufacture. The manufacturer may not want to use snaps if the blanket is intended to be used by a baby or toddler since the snaps could become detached and present a possible choking hazard to the baby or toddler. Also as before, the above description of the embodiment illustrated in FIG. 1 is illustrative only, and variations to the above-described approach may also be included in a blanket constructed according to the disclosed principles.

In embodiments in which loops of material used to fasten the Panels 110, 120, 130, all of the Panels 110, 120, 130 would be removably fastened together. In exemplary embodiments, small incisions may be made in all the Panels 110, 120, 130. The loops of material could then be inserted through the incisions and tied together in a number of different ways, thereby securing all the Panels 110, 120, 130 together. However, loops of material could get lost if they are not properly tied. Plus, loops of material are not secured to the panel like a button, snap, or Velcro®, and therefore may have a tendency to get lost. On the other hand, the loops of material could be changed at any time by the user for aesthetic reasons. Of course, this is just one exemplary technique for employing loops of materials to fasten the Panels 110, 120, 130 together, and variations to this approach may also be included in a blanket constructed according to the disclosed principles.

In embodiments in which ties are used to fasten the Panels 110, 120, 130, all of the Panels 110, 120, 130 would again be removably fastened together. In exemplary embodiments, small incisions may be made in Panels 120 and 130, and loops of material sewn or otherwise attached to Panel 110. The loops of material could then be inserted through the incisions in the upper Panels 120, 130, thereby securing all the Panels 110, 120, 130 together. Unlike loops of material not secured to the panels, loops of material sewn to the panels will less likely be lost. However, the user will not have the ease of changing the loops of material that are sewn as opposed to loops of material that are not sewn to the panels. Again, this is just one exemplary technique for employing ties of materials to fasten the Panels 110, 120, 130 together, and variations to this approach may also be included in a blanket constructed according to the disclosed principles.

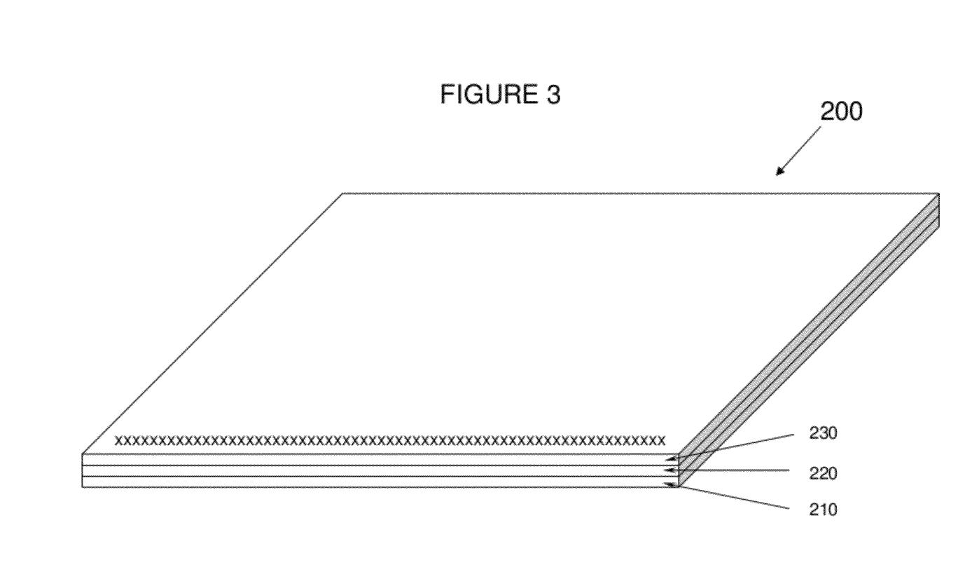

FIG. 3 illustrates an exemplary embodiment for a blanket 200 constructed according to the disclosed principles. Illustrated items of the blanket 200 in FIG. 3 include, in this embodiment, three different panel layers one over another: Panel 210, Panel 220, and Panel 230. Blanket 200 is comprised of panels 210, 220, 230, each of which has substantially the same dimensions along their widths and lengths, as illustrated in FIG. 3. In addition, in this embodiment, panel 210 has four sides (210a, 210b, 210c and 210d), panel 220 has four sides (220a, 220b, 220c and 220d), and panel 230 has four sides (230a, 230b, 230c and 230d). However, each of the panels 210, 220, 230 having four sides is merely illustrative, and thus panels have any number of sides, or no sides per se such as with round- or elliptical-shaped blankets, are also envisioned and fall within the scope of the present disclosure. FIG. 11 illustrates one possible cross section for blanket 200.

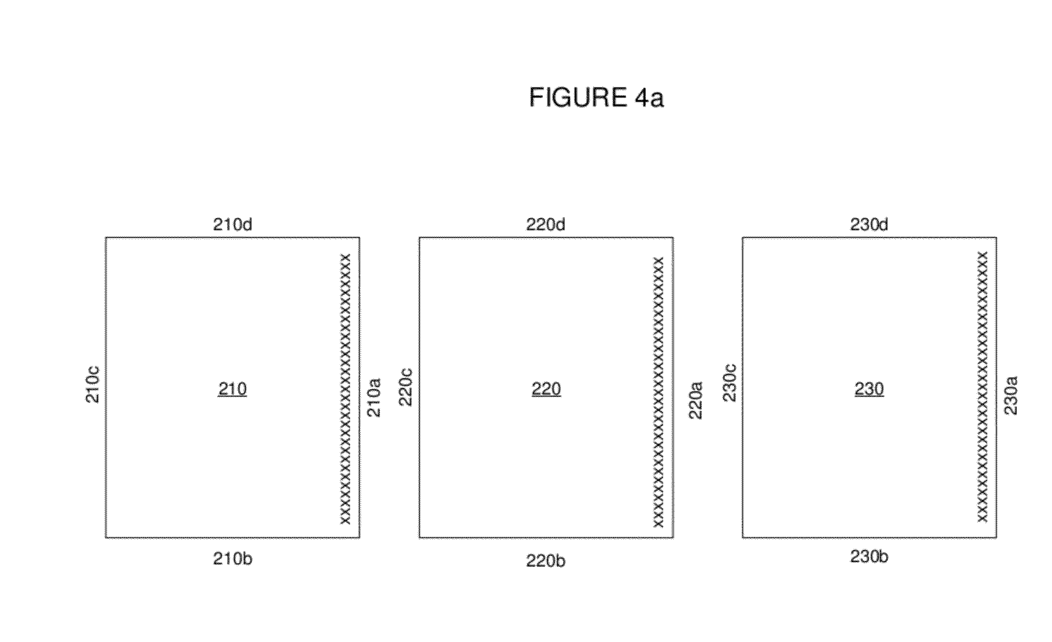

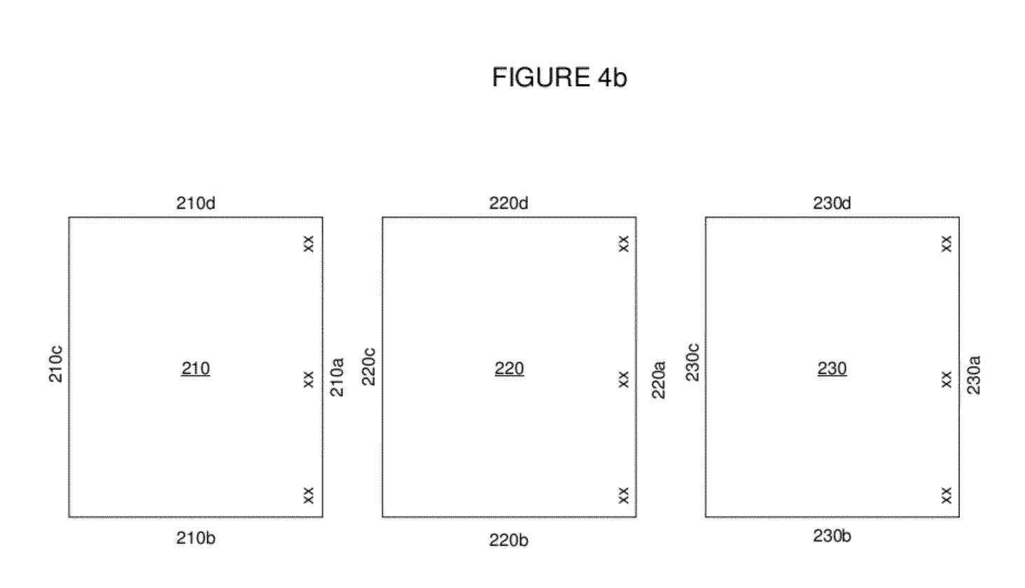

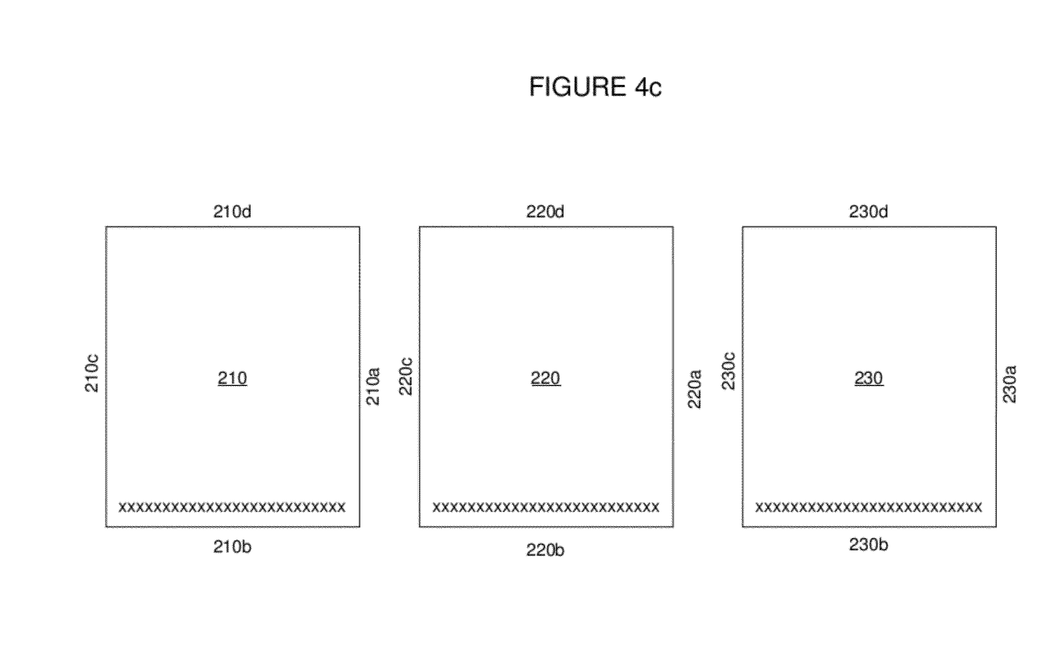

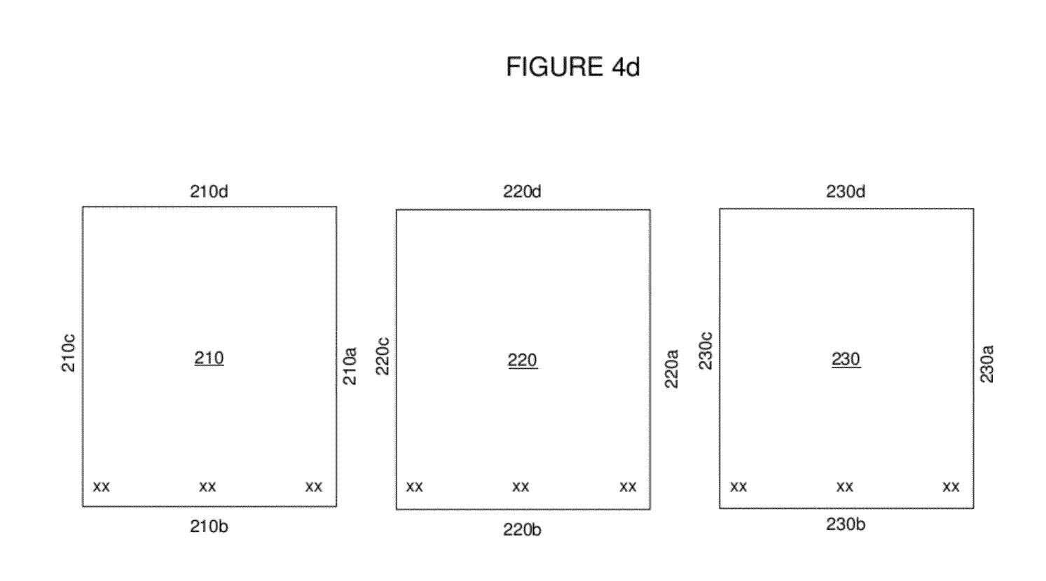

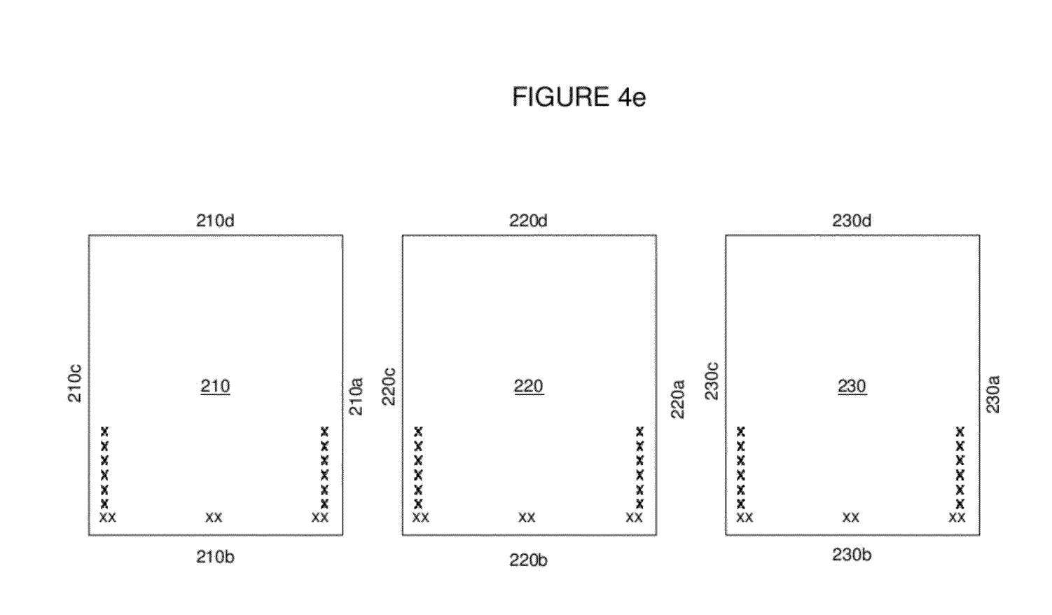

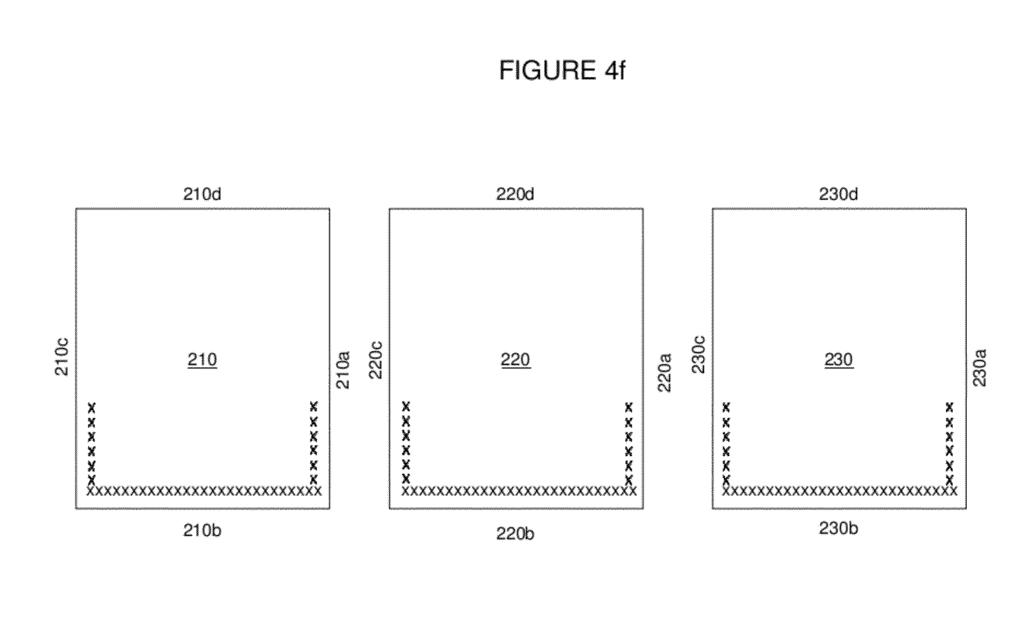

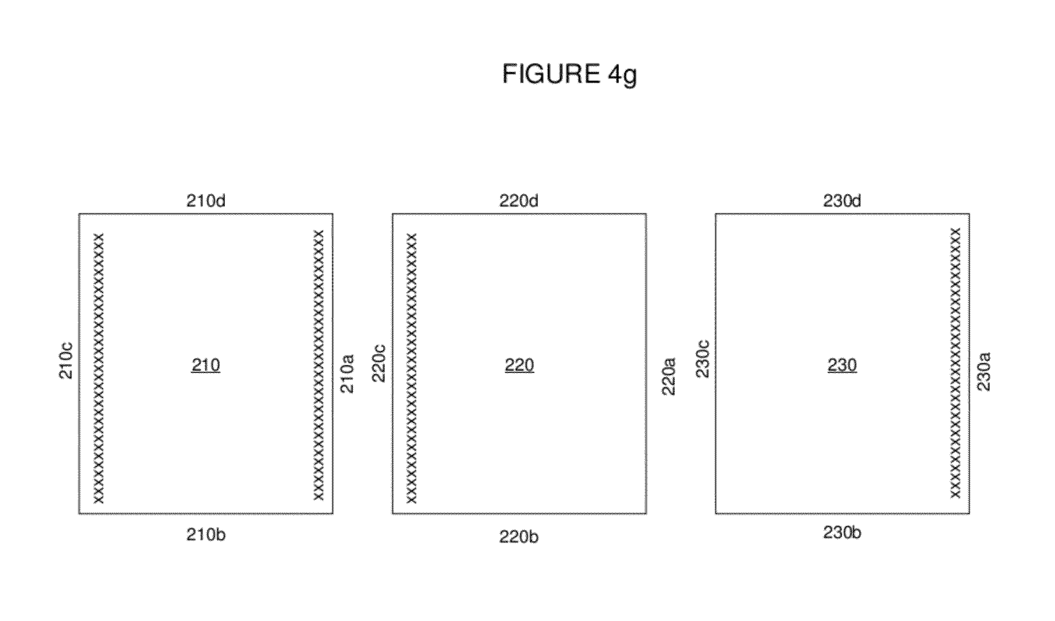

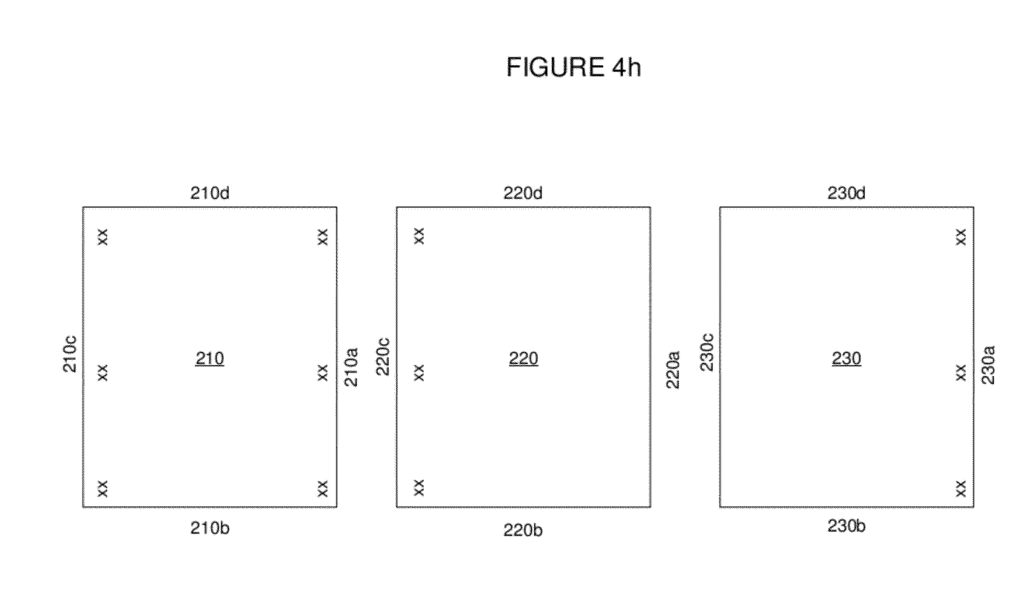

In this embodiment of a blanket constructed as disclosed herein, the attachment area is provided along one of the sides of the blanket 200. In such a case, the panels 210, 220, 230 of blanket 200 may therefore be opened much like a book. FIG. 4a illustrates such an attachment area substantially along all of sides 210a, 220a and 230a of panels 210, 220, 230, respectively. FIG. 4b again illustrates the attachment area of blanket 200 along sides 210a, 220a and 230a of panels 210, 220, 230, respectively, but in this embodiment the attachment means is provided only in the middle and at the ends of these sides 210a, 220a and 230a. However, in FIG. 4c, the attachment area is provided substantially along all of the bottom edges of sides 210b, 220b and 230b of panels 210, 220, 230, respectively. FIG. 4d also illustrates the attachment area of blanket 200 along the bottom edges of sides 210b, 220b and 230b of panels 210, 220, 230, respectively, but in this embodiment the attachment means is provided only in the middle and at the ends of these bottom sides 210b, 220b and 230b of blanket 200. FIG. 4e illustrates the attachment area of blanket 200 along the bottom edges of sides 210b, 220b and 230b of panels 210, 220, 230, respectively, but in this embodiment the attachment means is provided in the middle and at the ends of these bottom sides 210b, 220b and 230b and partially along the edges of 210a, 210c, 220a, 220c, 230a, and 230c of blanket 200. FIG. 4f illustrates the attachment area of blanket 200 substantially along the bottom sides 210b, 220b and 230b of panels 210, 220, 230, respectively, but in this embodiment the attachment means is provided at the ends of these bottom sides 210b, 220b and 230b and partially along the edges of 210a, 210c, 220a, 220c, 230a, and 230c of blanket 200.

In other similar embodiments, such as illustrated in FIG. 4g, such an attachment area substantially along all of sides 210a, 210c, 220c and 230a of panels 210, 220, 230, respectively. FIG. 4h again illustrates the attachment area of blanket 200 along sides 210a, 210c, 220c and 230a of panels 210, 220, 230, respectively, but in this embodiment the attachment means is provided only in the middle and at the ends of these sides 210a, 210c, 220c and 230a. Moreover, with such embodiments, if the base panel is laid upon by a user, for example, an infant, then the tri-fold structure of such embodiments could also more securely hold the infant within the blanket.

FIGS. 4a, 4b, 4c, and 4d illustrate the individual panels 210, 220, 230 and exemplary area of attachment along one side of each panel. FIGS. 4e and 4f illustrate the individual panels and area of attachment along multiple sides of the panels illustrated therein. FIGS. 4g and 4h illustrate the individual panels and area of attachment along single and multiple sides of the panels illustrated therein. The “X” represents the area of attachment. The area of attachment may be on the top, the bottom, or top and bottom of the panel as determined by the designer or manufacturer. In addition, the attachment of panels together to form the complete blanket may be a combination of these, such along the bottom edges of the panels, and then partially or completely up the sides of the panels.

In FIGS. 4a and 4b, a user's feet could be substantially towards sides 210b, 220b, and 230b with the user's head at 210d, 220d, and 230d with the user's side substantially parallel to the area of attachment. If the user preferred not to be in contact with another surface such as the carpet or ground, the user could lie on the panel 210 and cover himself or herself with panels 220 and 230 or any combination thereof. Alternatively, the user may want to cover himself or herself with panels 210, 220, and 230 or any combination thereof if lying on a bed, couch, or another surface preferred by the user. For a baby or toddler, the parent or caretaker may prefer to place the baby or toddler on the panel 210 regardless of the surface (e.g., couch, bed, carpet, or ground). FIG. 4a may provide more insulation and protection to the user than FIG. 4b since there is more area of attachment in 4a than 4b. Alternatively, a user's feet could be substantially towards sides 210d, 220d, and 230d with the user's head at 210b, 220b, and 230b with the user's side substantially parallel to the area of attachment. FIGS. 4a and 4b could allow the user to extend his or her feet beyond the 210b, 220b, and 230b edges or 210d, 220d, and 230d edges since there is no attachment(s) along these edges. This would be a personal preference of the user.

In FIGS. 4c and 4d, a user's feet could be substantially towards sides 210b, 220b, and 230b with the user's head at 210d, 220d, and 230d. If the user preferred not to be in contact with another surface such as the carpet or ground, the user could lie on the panel 210 and cover himself or herself with panels 220 and 230 or any combination thereof. Alternatively, the user may want to cover himself or herself with panels 210, 220, and 230 or any combination thereof if lying on a bed, couch, or another surface preferred by the user. For a baby or toddler, the parent or caretaker may prefer to place the baby or toddler on the panel 210 regardless of the surface (e.g., couch, bed, carpet, or ground). FIG. 4c may provide more insulation and protection to the user than FIG. 4d since there is more area of attachment in 4c than 4d. Since FIGS. 4c and 4d have attachments along 210b, 220b, and 230b, the user may prefer to have his or her feet covered by one or more of the panels.

In FIGS. 4e and 4f, a user's feet could be substantially towards sides 210b, 220b, and 230b with the user's head at 210d, 220d, and 230d. If the user preferred not to be in contact with another surface such as the carpet or ground, the user could lie on panel 210 and cover himself or herself with panels 220 and 230 or any combination thereof. For a baby or toddler, the parent or caretaker may prefer to place the baby or toddler on panel 210 regardless of the surface (e.g., couch, bed, carpet, or ground). When the sides and bottom edges of the panels are attached, it creates a structure like a pocket on a shirt. A parent or caretaker may be interested in this embodiment since it creates a substantially enclosed structure to secure the baby. FIG. 4e may provide more insulation and protection to the user than FIG. 4f since there is more area of attachment in 4e than 4f.

In FIGS. 4g and 4h, a user's feet could be substantially towards sides 210b, 220b, and 230b with the user's head at 210d, 220d, and 230d with the user's side substantially parallel to the area of attachment. If the user preferred not to be in contact with another surface such as the carpet or ground, the user could lie on the panel 210 and cover himself or herself with panels 220 and 230 or any combination thereof. Alternatively, the user may want to cover himself or herself with panels 210, 220, and 230 or any combination thereof if lying on a bed, couch, or another surface preferred by the user. For a baby or toddler, the parent or caretaker may prefer to place the baby or toddler on the panel 210 regardless of the surface (e.g., couch, bed, carpet, or ground). Alternatively, a user's feet could be substantially towards sides 210d, 220d, and 230d with the user's head at 210b, 220b, and 230b with the user's side substantially parallel to the area of attachment. Instead of the panels laying on top on each other, they could be laid substantially flat thereby creating a larger surface area for sleeping or for playing. FIG. 4g may provide more insulation and protection to the user than FIG. 4h since there is more area of attachment in 4g than 4h. The method of attachment could be but is not limited to stitching, zippers, snaps, Velcro®, loops of material, buttons, or ties. The designer or manufacturer may also decide to use several methods of attachment such as buttons on Panel 210, snaps on Panel 220, and Velcro® on Panel 230 or any combination thereof.

In embodiments in which buttons are used to fasten the panels illustrated in FIG. 3, each of the panels may be comprised as follows:
Panel 210 top side: buttons along the attachment edge. The buttons may be inserted through the button hole of Panel 220 and the button hole of Panel 230 and be visible on the top side of Panel 230.
Panel 210 bottom side: buttons may be included for aesthetics only, though not required.
Panel 220: button holes passing completely through Panel 220. (Optionally, buttons could be added along the attachment edge in addition to the button holes. The buttons of Panel 220 may be inserted through the button hole of Panel 230 such that the buttons of Panel 220 would be visible on the top side of Panel 230.)
Panel 230: button holes passing completely through Panel 230
   The time to fasten or unfasten the various panels will depend on the user and the number of buttons on each panel. Buttons may also need to be re-attached since they could become loose, fall off, or are physically removed by a user such as a baby or toddler. Plus, more buttons per panel could make the blanket more expensive to manufacture. The manufacturer may not want to use buttons if the blanket is intended to be used by a baby or toddler since the buttons could become detached and present a possible choking hazard to the baby or toddler. Also, as with other embodiments, the above description of the embodiment illustrated in FIG. 3 is illustrative only, and variations to the above-described approach may also be included in a blanket constructed according to the disclosed principles.

In embodiments in which hook-and-loop fasteners (e.g., Velcro®) are used to fasten the panels illustrated in FIG. 3, each of the panels may be comprised as follows:
Panel 210 top side: hook-and-loop material.
Panel 210 bottom side: hook-and-loop material may be included for aesthetics only, though not required.
Panel 220 top side: hook-and-loop material along the attachment edge although not required in FIGS. 4g and 4h.
Panel 220 bottom side: hook-and-loop material.
Panel 230 top side: nothing along the attachment edge.
Panel 230 bottom side: hook-and-loop material along the attachment edge.
   Velcro® may be less likely to detach from one of the panels as opposed to buttons. Plus, it could be faster and easier for a user to attach or detach panels which use Velcro® as opposed to buttons. However, Velcro® may adhere to other fabrics which could be undesirable by the user and may damage the other fabrics. Of course, the above description of the embodiment illustrated in FIG. 3 is illustrative only, and variations to the above-described approach may also be included in a blanket constructed according to the disclosed principles.

In embodiments in which zippers are used to fasten the panels illustrated in FIG. 3, each of the panels may be comprised as follows:
A single zipper connecting all three Panels 210, 220, 230 together along an attachment edge or side of each; or
A first zipper connecting all Panels 210 and 220 together along their attachment edges, and a second zipper connecting all Panels 220 and 230 together along an attachment edge or side of each. (Optionally, a first zipper connecting all Panels 210 and 220 together along their attachment edges, and a second zipper connecting all Panels 210 and 230 together along an attachment edge or side of each for FIGS. 4g and 4h.)
   As a method of attachment, a zipper could be faster means of adding and removing panels as opposed to other methods such as buttons or snaps. However, a user may need to take special care when using a zipper so that the material of the panel does not get caught in the zipper. Also, the above description of the embodiment illustrated in FIG. 3 is illustrative only, and variations to the above-described approach may also be included in a blanket constructed according to the disclosed principles.

In embodiments in which stitching is used, all three Panels 210, 220, 230 are stitched together and would not be removably fastened together. In FIGS. 4g and 4h, Panels 210 and 220 are stitched together and would not be removably fastened together, and Panels 210 and 230 are stitched together and would not be removably fastened together. Stitching could be an inexpensive method of attaching the panels with compared to other methods disclosed herein since the manufacturer does not have the added expense of material (e.g., buttons, zippers, Velcro, snaps) and labor and skill required to attach said material.

In embodiments in which snaps are used to fasten the panels illustrated in FIG. 3 (where each snap has a male and female part), each of the panels may be comprised as follows:
Panel 210 top side: male snaps along the attachment edge.
Panel 210 bottom side: female or male snaps may be included for aesthetics only, though not required.
Panel 220 top side: male snaps along the attachment edge although not required in FIGS. 4g and 4h.
Panel 220 bottom side: female snaps along the attachment edge.
Panel 230 top side: female or male snaps may be included for aesthetics only, though not required.
Panel 230 bottom side: female snaps along the attachment edge.
   Like buttons, the time to fasten or unfasten the various panels will depend on the user and the number of snaps on each panel. Snaps may also need to be re-attached since they could become loose, fall off, or are physically removed by a user such as a baby or toddler. Plus, more snaps per panel could make the blanket more expensive to manufacture. The manufacturer may not want to use snaps if the blanket is intended to be used by a baby or toddler since the snaps could become detached and present a possible choking hazard to the baby or toddler. Also, the above description of the embodiment illustrated in FIG. 3 is illustrative only, and variations to the above-described approach may also be included in a blanket constructed according to the disclosed principles.

In embodiments in which loops of material used to fasten the Panels 210, 220, 230, all of the Panels 210, 220, 230 would be removably fastened together. In exemplary embodiments, small incisions may be made in all the Panels 210, 220, 230. The loops of material could then be inserted through the incisions and tied together in a number of different ways, thereby securing all the Panels 210, 220, 230 together. However, loops of material could get lost if they are not properly tied. Plus, loops of material are not secured to the panel like a button, snap, or Velcro® and therefore may have a tendency to get lost. On the other hand, the loops of material could be changed at any time by the user for aesthetic reasons. Of course, this is just one exemplary technique for employing loops of materials to fasten the Panels 210, 220, 230 together, and variations to this approach may also be included in a blanket constructed according to the disclosed principles.

In embodiments in which ties are used to fasten the Panels 210, 220, 230, all of the Panels 210, 220, 230 would again be removably fastened together. In exemplary embodiments, small incisions may be made in Panels 220 and 230, and loops of material sewn or otherwise attached to Panel 210. The loops of material could then be inserted through the incisions in the upper Panels 220, 230, thereby securing all the Panels 210, 220, 230 together. Unlike loops of material not secured to the panels, loops of material sewn or attached to the panels will less likely get lost. However, the user will not have the ease of changing the loops of material that are sewn or attached as opposed to loops of material that are not secured to the panels. Of course, this is just one exemplary technique for employing ties of materials to fasten the Panels 210, 220, 230 together, and variations to this approach may also be included in a blanket constructed according to the disclosed principles.

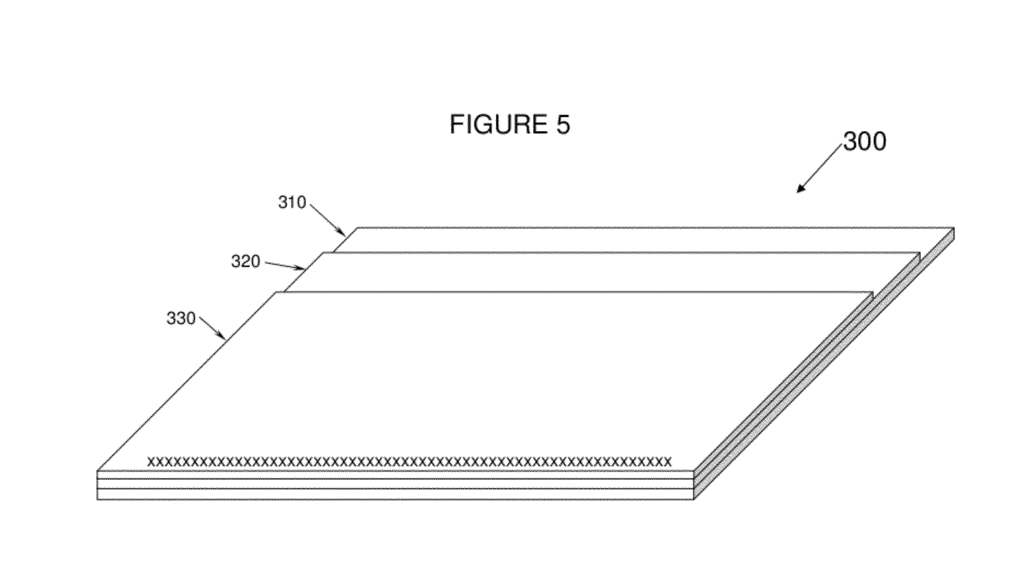

FIG. 5 illustrates an exemplary embodiment for a blanket 300 constructed according to the disclosed principles. Illustrated items of the blanket 300 in FIG. 5 include, in this embodiment, three different panel layers one over another: Panel 310, Panel 320, and Panel 330. Blanket 300 is comprised of panels 310, 320, 330, each of which have different dimensions along their lengths, but have substantially the same dimensions along their widths, as illustrated in FIG. 5. In addition, in this embodiment, panel 310 has four sides (310a, 310b, 310c and 310d), panel 320 has four sides (320a, 320b, 320c and 320d), and panel 330 has four sides (330a, 330b, 330c and 330d). Each of the panels 310, 320, 330 having four sides is merely illustrative, and thus panels have any number of sides, or no sides per se such as with round- or elliptical-shaped blankets, are also envisioned and fall within the scope of the present disclosure. FIG. 11 illustrates one possible cross section for blanket 300.

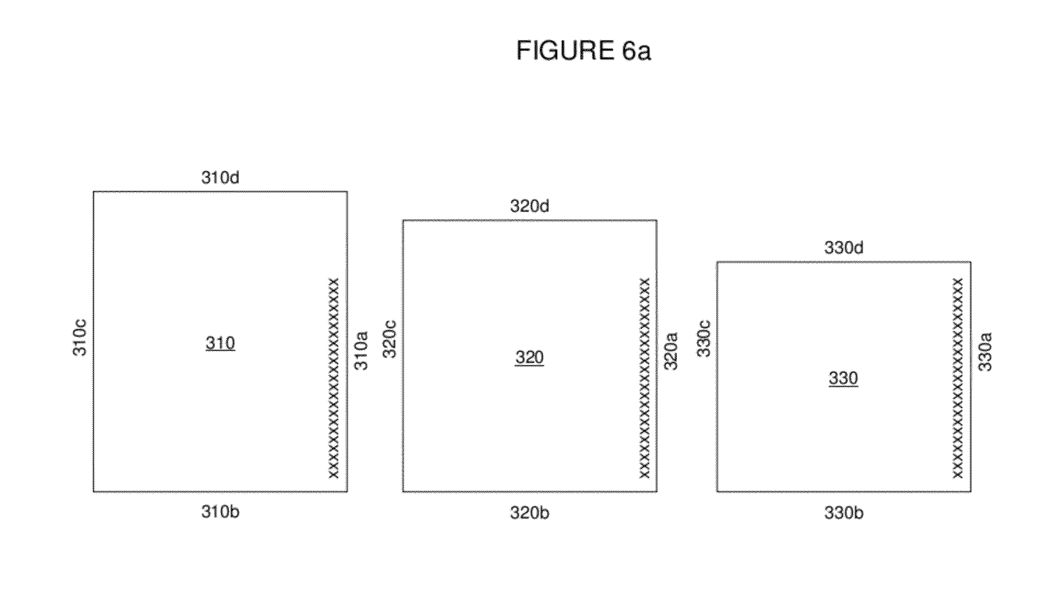

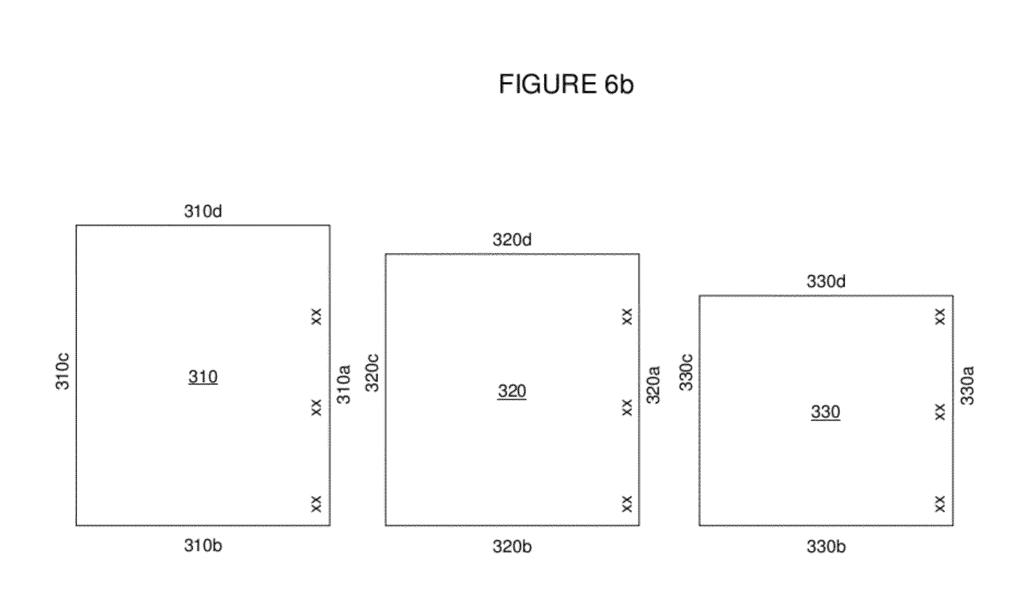

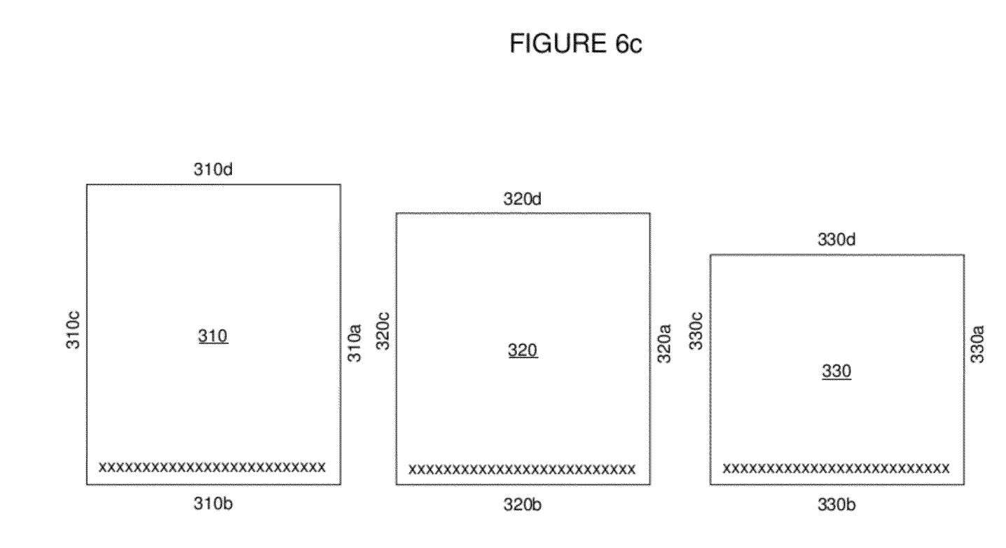

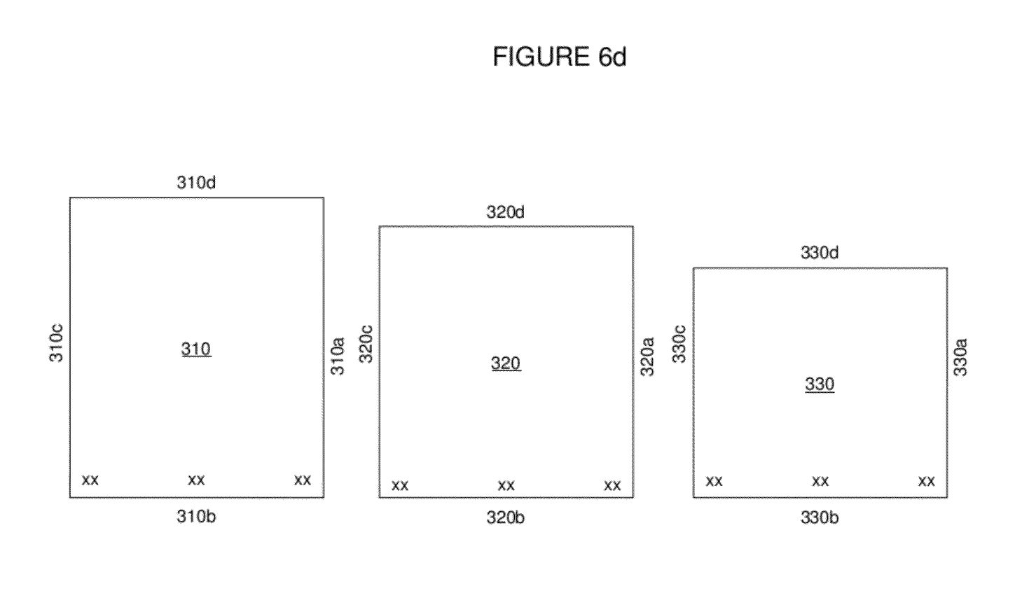

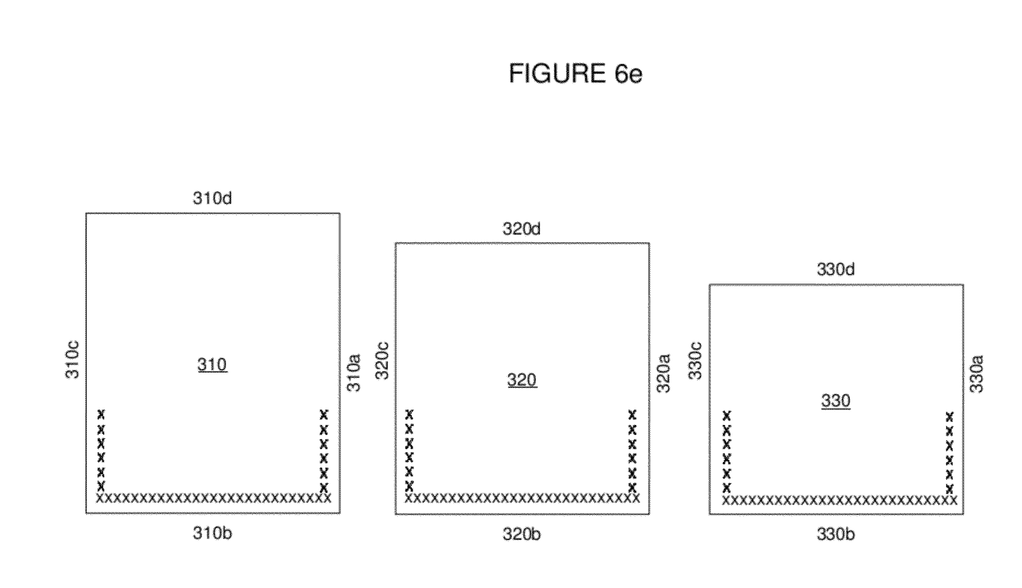

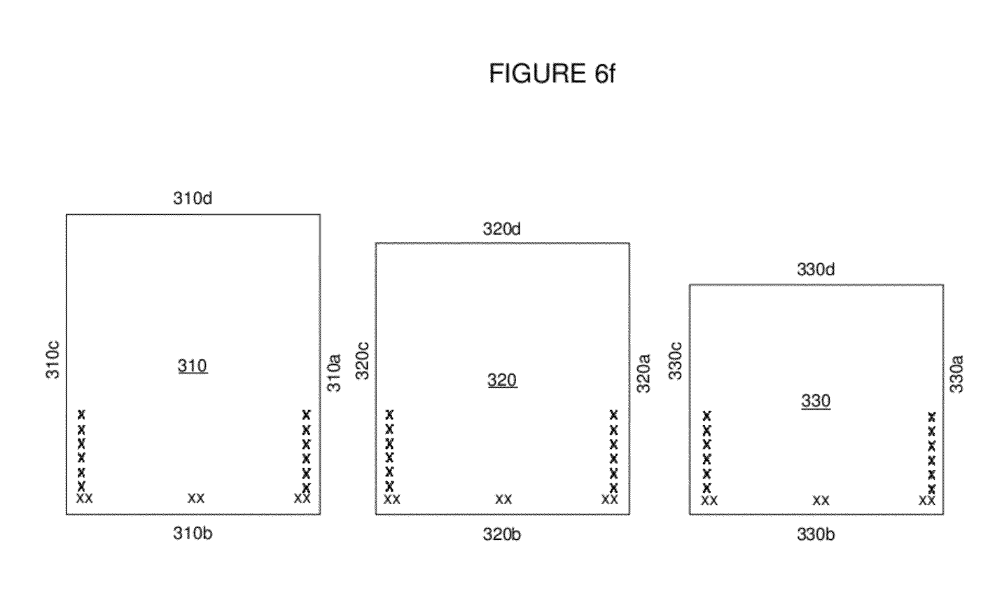

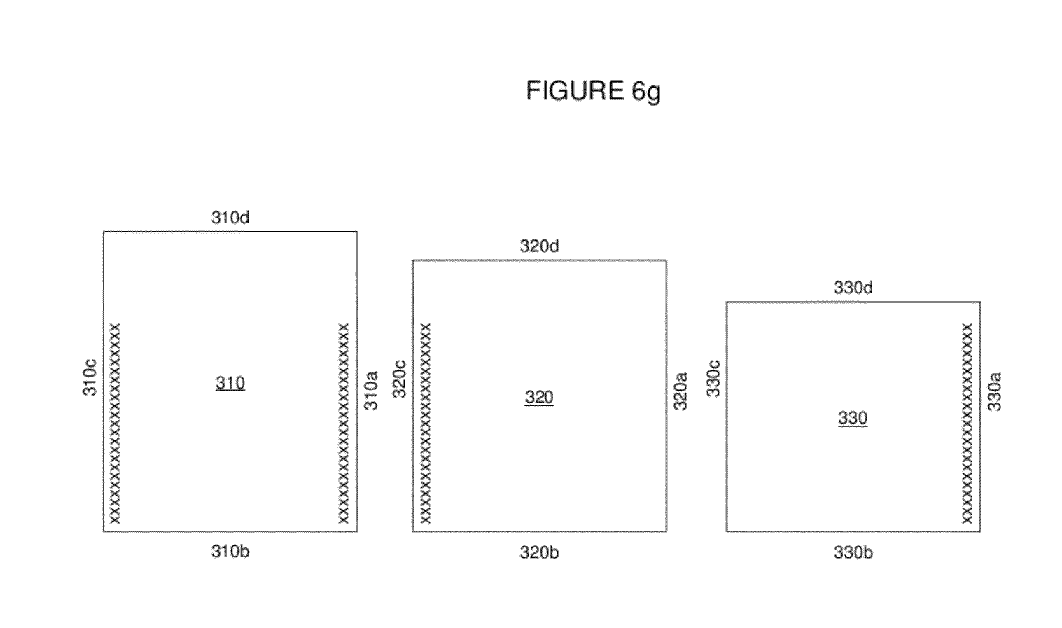

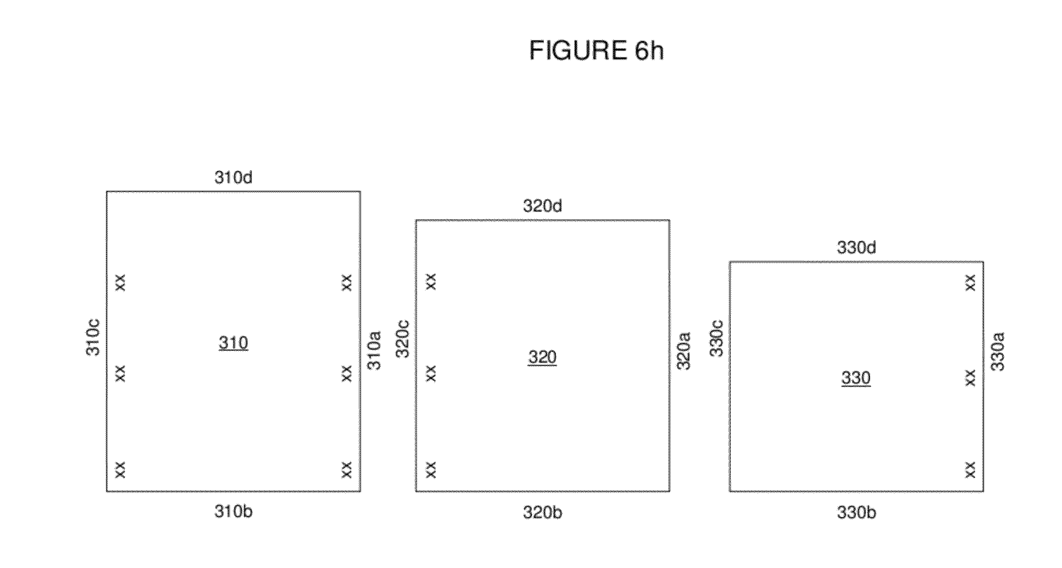

In this embodiment of a blanket constructed as disclosed herein, the attachment area is provided along one of the sides of the blanket 300. In such a case, the panels 310, 320, 330 of blanket 300 may therefore be opened much like a book. FIG. 6a illustrates such an attachment area substantially along all of sides 310a, 320a and 330a of panels 310, 320, 330, respectively. FIG. 6b again illustrates the attachment area of blanket 300 along sides 310a, 320a and 330a of panels 310, 320, 330, respectively, but in this embodiment the attachment means is provided only in the middle and at the ends of these sides 310a, 320a and 330a. However, in FIG. 6c, the attachment area is provided substantially along all of the bottom edges of sides 310b, 320b and 330b of panels 310, 320, 330, respectively. FIG. 6d also illustrates the attachment area of blanket 300 along the bottom edges of sides 310b, 320b and 330b of panels 310, 320, 330, respectively, but in this embodiment the attachment means is provided only in the middle and at the ends of these bottom sides 310b, 320b and 330b of blanket 300. FIG. 6e illustrates the attachment area of blanket 300 along the bottom edges of sides 310b, 320b and 330b of panels 310, 320, 330, respectively, but in this embodiment the attachment means is provided in the middle and at the ends of these bottom sides 310b, 320b and 330b and partially along the edges of 310a, 310c, 320a, 320c, 330a, and 330c of blanket 300. FIG. 6f illustrates the attachment area of blanket 300 substantially along the bottom sides 310b, 320b and 330b of panels 310, 320, 330, respectively, but in this embodiment the attachment means is provided at the ends of these bottom sides 310b, 320b and 330b and partially along the edges of 310a, 310c, 320a, 320c, 330a, and 330c of blanket 300.

FIG. 6g illustrates such an attachment area substantially along all of sides 310a, 310c, 320c and 330a of panels 310, 320, 330, respectively. FIG. 6h again illustrates the attachment area of blanket 300 along sides 310a, 310c, 320c and 330a of panels 310, 320, 330, respectively, but in this embodiment the attachment means is provided only in the middle and at the ends of these sides 310a, 310c, 320c and 330a.

FIGS. 6a, 6b, 6c, and 6d illustrate the individual panels 310, 320, 330 and exemplary area of attachment along one side of each panel. FIGS. 6e and 6f illustrate the individual panels and area of attachment along multiple sides of the panels illustrated therein. FIGS. 6g and 6h illustrate the individual panels and area of attachment along single and multiple sides of the panels illustrated therein. The “X” represents the area of attachment. The area of attachment may be on the top, the bottom, or top and bottom of the panel as determined by the designer or manufacturer. In addition, the attachment of panels together to form the complete blanket may be a combination of these, such along the bottoms of the panels, and then partially or completely up the sides of the panels.

In FIGS. 6a and 6b, a user's feet could be substantially towards sides 310b, 320b, and 330b with the user's head at 310d, 320d, and 330d with the user's side substantially parallel to the area of attachment. If the user preferred not to be in contact with another surface such as the carpet or ground, the user could lie on the panel 310 and cover himself or herself with panels 320 and 330 or any combination thereof. Alternatively, the user may want to cover himself or herself with panels 310, 320, and 330 or any combination thereof if lying on a bed, couch, or another surface preferred by the user. For a baby or toddler, the parent or caretaker may prefer to place the baby or toddler on the panel 310 regardless of the surface (e.g., couch, bed, carpet, or ground). FIG. 6a may provide more insulation and protection to the user than FIG. 6b since there is more area of attachment in 6a than 6b. Alternatively, a user's feet could be substantially towards sides 310d, 320d, and 330d with the user's head at 310b, 320b, and 330b with the user's side substantially parallel to the area of attachment. FIGS. 6a and 6b could allow the user to extend his or her feet beyond the 310b, 320b, and 330b edges or 310d, 320d, and 330d edges since there is no attachment(s) along these edges. This would be a personal preference of the user.

In FIGS. 6c and 6d, a user's feet could be substantially towards sides 310b, 320b, and 330b with the user's head at 310d, 320d, and 330d. If the user preferred not to be in contact with another surface such as the carpet or ground, the user could lie on the panel 310 and cover himself or herself with panels 320 and 330 or any combination thereof. Alternatively, the user may want to cover himself or herself with panels 310, 320, and 330 or any combination thereof if lying on a bed, couch, or another surface preferred by the user. For a baby or toddler, the parent or caretaker may prefer to place the baby or toddler on the panel 310 regardless of the surface (e.g., couch, bed, carpet, or ground). FIG. 6c may provide more insulation and protection to the user than FIG. 6d since there is more area of attachment in 6c than 6d. Since FIGS. 6c and 6d have attachments along 310b, 320b, and 330b, the user may prefer to have his or her feet covered by one or more of the panels.

In FIGS. 6e and 6f, a user's feet could be substantially towards sides 310b, 320b, and 330b with the user's head at 310d, 320d, and 330d. If the user preferred not to be in contact with another surface such as the carpet or ground, the user could lie on panel 310 and cover himself or herself with panels 320 and 330 or any combination thereof. For a baby or toddler, the parent or caretaker may prefer to place the baby or toddler on panel 310 regardless of the surface (e.g., couch, bed, carpet, or ground). When the sides and bottom edges of the panels are attached, it creates a structure like a pocket on a shirt. A parent or caretaker may be interested in this embodiment since it creates a substantially enclosed structure to secure the baby. FIG. 6e may provide more insulation and protection to the user than FIG. 6f since there is more area of attachment in 6e than 6f.

In FIGS. 6g and 6h, a user's feet could be substantially towards sides 310b, 320b, and 330b with the user's head at 310d, 320d, and 330d with the user's side substantially parallel to the area of attachment. If the user preferred not to be in contact with another surface such as the carpet or ground, the user could lie on the panel 310 and cover himself or herself with panels 320 and 330 or any combination thereof. Alternatively, the user may want to cover himself or herself with panels 310, 320, and 330 or any combination thereof if lying on a bed, couch, or another surface preferred by the user. For a baby or toddler, the parent or caretaker may prefer to place the baby or toddler on the panel 310 regardless of the surface (e.g., couch, bed, carpet, or ground). Alternatively, a user's feet could be substantially towards sides 310d, 320d, and 330d with the user's head at 310b, 320b, and 330b with the user's side substantially parallel to the area of attachment. Instead of the panels laying on top on each other, they could be laid substantially flat thereby creating a larger surface area for sleeping or for playing. FIG. 6g may provide more insulation and protection to the user than FIG. 6h since there is more area of attachment in 6g than 6h.

The method of attachment could be but is not limited to stitching, zippers, snaps, Velcro®, loops of material, buttons, or ties. The designer or manufacturer may also decide to use several methods of attachment such as buttons on Panel 310, snaps on Panel 320, and Velcro® on Panel 330 or any combination thereof.

In embodiments in which buttons are used to fasten the panels illustrated in FIG. 5, each of the panels may be comprised as follows:
Panel 310 top side: buttons along the attachment edge. The buttons may be inserted through the button hole of Panel 320 and the button hole of Panel 330 and be visible on the top side of Panel 330.
Panel 310 bottom side: buttons may be included for aesthetics only, though not required.
Panel 320: button holes passing completely through Panel 320. (Optionally, buttons could be added along the attachment edge in addition to the button holes. The buttons of Panel 320 may be inserted through the button hole of Panel 330 such that the buttons of Panel 320 would be visible on the top side of Panel 330.)
Panel 330: button holes passing completely through Panel 330
   The time to fasten or unfasten the various panels will depend on the user and the number of buttons on each panel. Buttons may also need to be re-attached since they could become loose, fall off, or are physically removed by a user such as a baby or toddler. Plus, more buttons per panel could make the blanket more expensive to manufacture. The manufacturer may not want to use buttons if the blanket is intended to be used by a baby or toddler since the buttons could become detached and present a possible choking hazard to the baby or toddler. Of course, the above description of the embodiment illustrated in FIG. 5 is illustrative only, and variations to the above-described approach may also be included in a blanket constructed according to the disclosed principles.

In embodiments in which hook-and-loop fasteners (e.g., Velcro®) are used to fasten the panels illustrated in FIG. 5, each of the panels may be comprised as follows:
Panel 310 top side: hook-and-loop material.
Panel 310 bottom side: hook-and-loop material may be included for aesthetics only, though not required.
Panel 320 top side: hook-and-loop material along the attachment edge although not required in FIGS. 6g and 6h.
Panel 320 bottom side: hook-and-loop material.
Panel 330 top side: nothing along the attachment edge.
Panel 330 bottom side: hook-and-loop material along the attachment edge.
   Velcro® may be less likely to detach from one of the panels as opposed to buttons. Plus, it could be faster and easier for a user to attach or detach panels which use Velcro® as opposed to buttons. However, Velcro® may adhere to other fabrics which could be undesirable by the user and may damage the other fabrics. Of course, the above description of the embodiment illustrated in FIG. 5 is illustrative only, and variations to the above-described approach may also be included in a blanket constructed according to the disclosed principles.

In embodiments in which zippers are used to fasten the panels illustrated in FIG. 5, each of the panels may be comprised as follows:
A single zipper connecting all three Panels 310, 320, 330 together along an attachment edge or side of each; or
A first zipper connecting all Panels 310 and 320 together along their attachment edges, and a second zipper connecting all Panels 320 and 330 together along an attachment edge or side of each. (Optionally, a first zipper connecting all Panels 310 and 320 together along their attachment edges, and a second zipper connecting all Panels 310 and 330 together along an attachment edge or side of each for FIGS. 6g and 6h.)
   As a method of attachment, a zipper could be faster means of adding and removing panels as opposed to other methods such as buttons or snaps. However, a user may need to take special care when using a zipper so that the material of the panel does not get caught in the zipper. Of course, the above description of the embodiment illustrated in FIG. 5 is illustrative only, and variations to the above-described approach may also be included in a blanket constructed according to the disclosed principles.

In embodiments in which stitching is used, all three Panels 310, 320, 330 are stitched together and would not be removably fastened together. In FIGS. 6g and 6h, Panels 310 and 320 are stitched together and would not be removably fastened together, and Panels 310 and 330 are stitched together and would not be removably fastened together. Stitching could be an inexpensive method of attaching the panels with compared to other methods disclosed herein since the manufacturer does not have the added expense of material (e.g., buttons, zippers, Velcro, snaps) and labor and skill required to attach said material.

In embodiments in which snaps are used to fasten the panels illustrated in FIG. 5 (where each snap has a male and female part), each of the panels may be comprised as follows:
Panel 310 top side: male snaps along the attachment edge.
Panel 310 bottom side: female or male snaps may be included for aesthetics only, though not required.
Panel 320 top side: male snaps along the attachment edge although not required in FIGS. 6g and 6h.
Panel 320 bottom side: female snaps along the attachment edge.
Panel 330 top side: female or male snaps may be included for aesthetics only, though not required.
Panel 330 bottom side: female snaps along the attachment edge.
   Like buttons, the time to fasten or unfasten the various panels will depend on the user and the number of snaps on each panel. Snaps may also need to be re-attached since they could become loose, fall off, or are physically removed by a user such as a baby or toddler. Plus, more snaps per panel could make the blanket more expensive to manufacture. The manufacturer may not want to use snaps if the blanket is intended to be used by a baby or toddler since the snaps could become detached and present a possible choking hazard to the baby or toddler. Of course, the above description of the embodiment illustrated in FIG. 5 is illustrative only, and variations to the above-described approach may also be included in a blanket constructed according to the disclosed principles.

In embodiments in which loops of material used to fasten the Panels 310, 320, 330, all of the Panels 310, 320, 330 would be removably fastened together. In exemplary embodiments, small incisions may be made in all the Panels 310, 320, 330. The loops of material could then be inserted through the incisions and tied together in a number of different ways, thereby securing all the Panels 310, 320, 330 together. However, loops of material could get lost if they are not properly tied. Plus, loops of material are not secured to the panel like a button, snap, or Velcro® and therefore may have a tendency to get lost. On the other hand, the loops of material could be changed at any time by the user for aesthetic reasons. Of course, this is just one exemplary technique for employing loops of materials to fasten the Panels 310, 320, 330 together, and variations to this approach may also be included in a blanket constructed according to the disclosed principles.

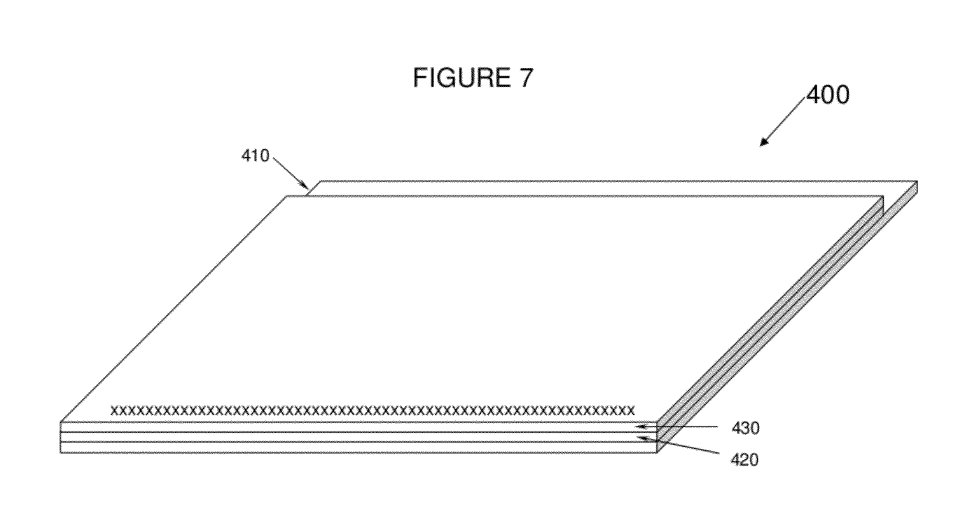

In embodiments in which ties are used to fasten the Panels 310, 320, 330, all of the Panels 310, 320, 330 would again be removably fastened together. In exemplary embodiments, small incisions may be made in Panels 320 and 330, and loops of material sewn or otherwise attached to Panel 310. The loops of material could then be inserted through the incisions in the upper Panels 320, 330, thereby securing all the Panels 310, 320, 330 together. Unlike loops of material not secured to the panels, loops of material sewn to the panels will less likely get lost. However, the user will not have the ease of changing the loops of material that are sewn as opposed to loops of material that are not sewn to the panels. Of course, this is just one exemplary technique for employing ties of materials to fasten the Panels 310, 320, 330 together, and variations to this approach may also be included in a blanket constructed according to the disclosed principles. FIG. 7 illustrates an exemplary embodiment for a blanket 400 constructed according to the disclosed principles. Illustrated items of the blanket 400 in FIG. 7 include, in this embodiment, three different panel layers one over another: Panel 410, Panel 420, and Panel 430. Blanket 400 is comprised of panels 410, 420, 430. Panels 410, 420, and 430 have substantially the same dimensions along their widths, as illustrated in FIG. 7. Panels 420 and 430 have substantially the same dimensions along their lengths, as illustrated in FIG. 7. Panel 410 has different dimension along its lengths than Panels 420 and 430, as illustrated in FIG. 7. In addition, in this embodiment, panel 410 has four sides (410a, 410b, 410c and 410d), panel 420 has four sides (420a, 420b, 420c and 420d), and panel 430 has four sides (430a, 430b, 430c and 430d). Each of the panels 410, 420, 430 having four sides is merely illustrative, and thus panels have any number of sides, or no sides per se such as with round- or elliptical-shaped blankets, are also envisioned and fall within the scope of the present disclosure. FIG. 11 illustrates one possible cross section for blanket 400.

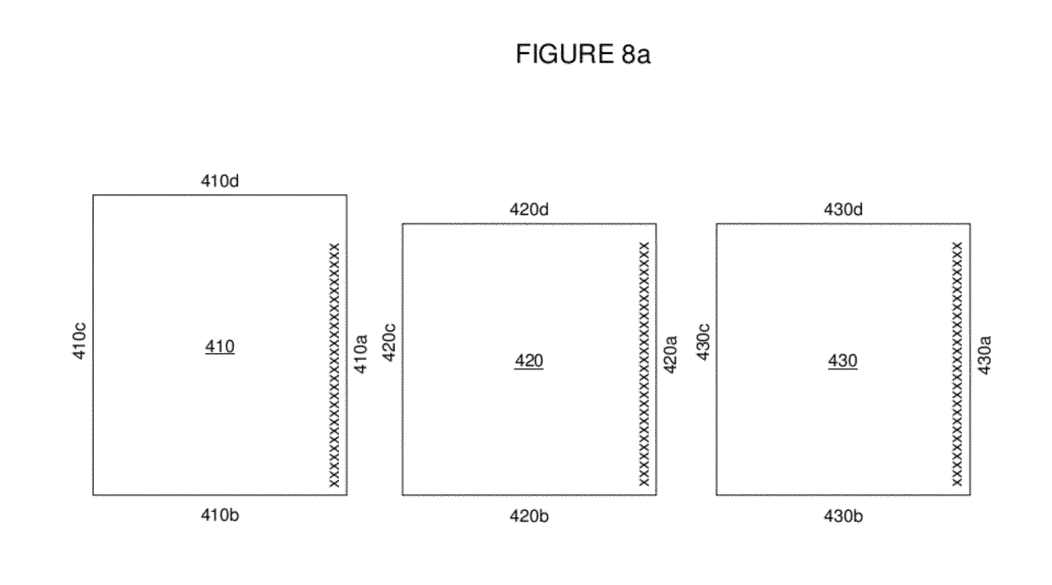

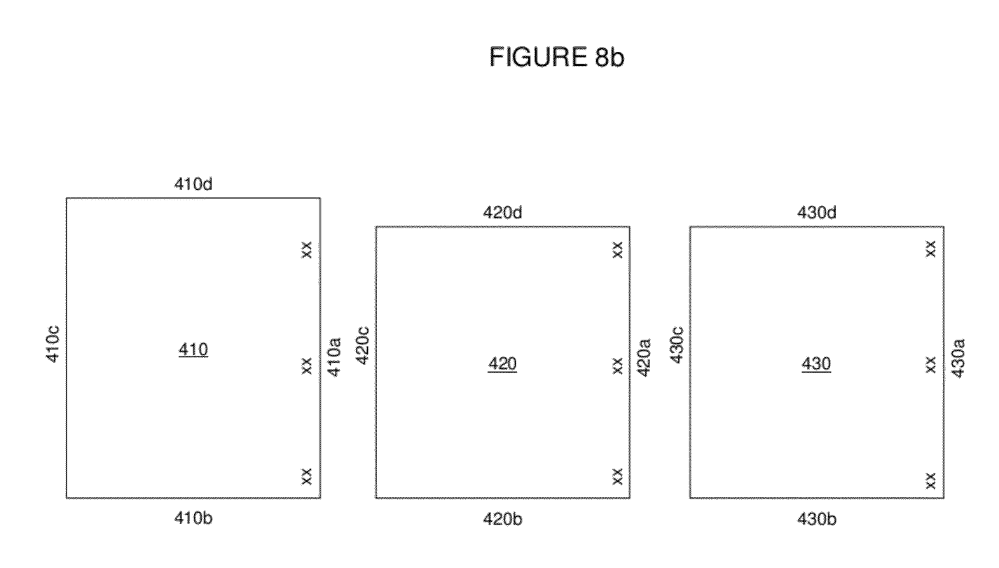

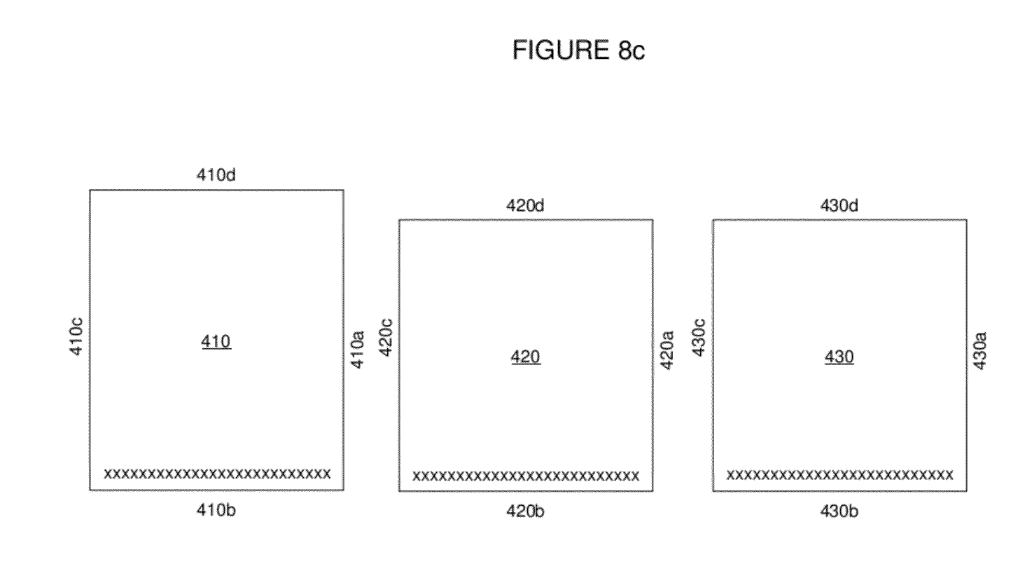

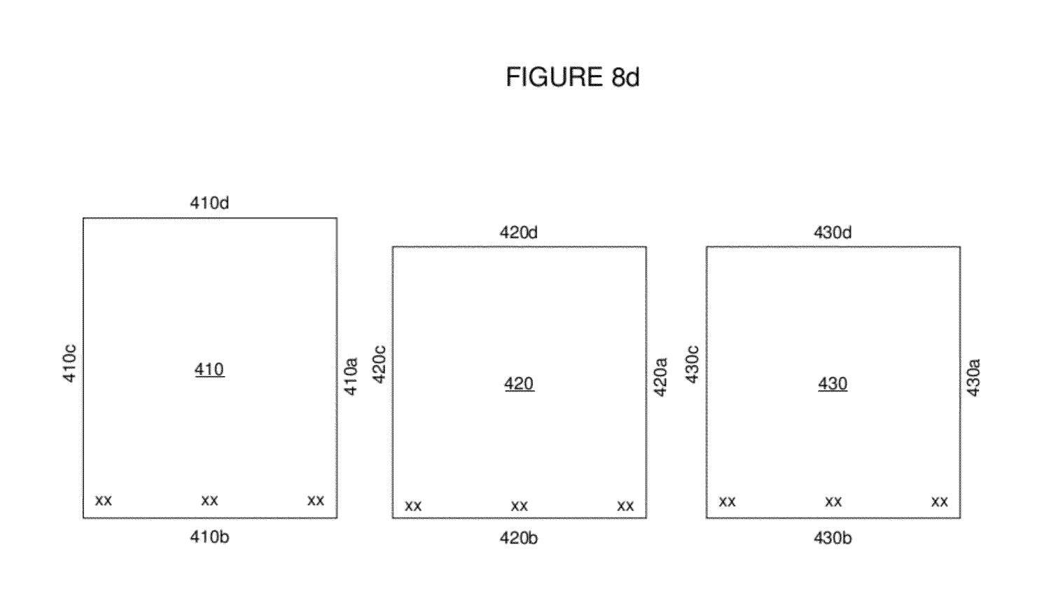

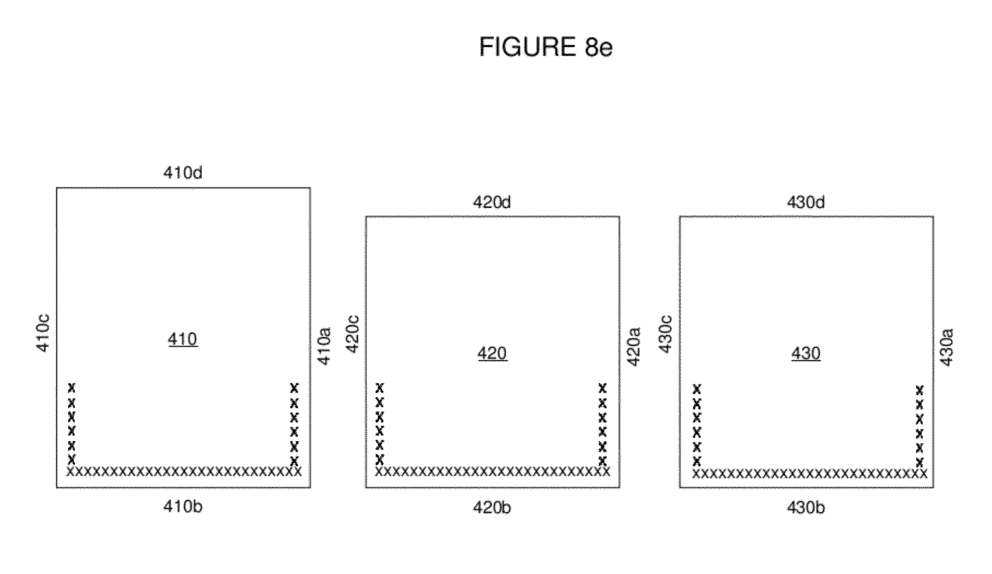

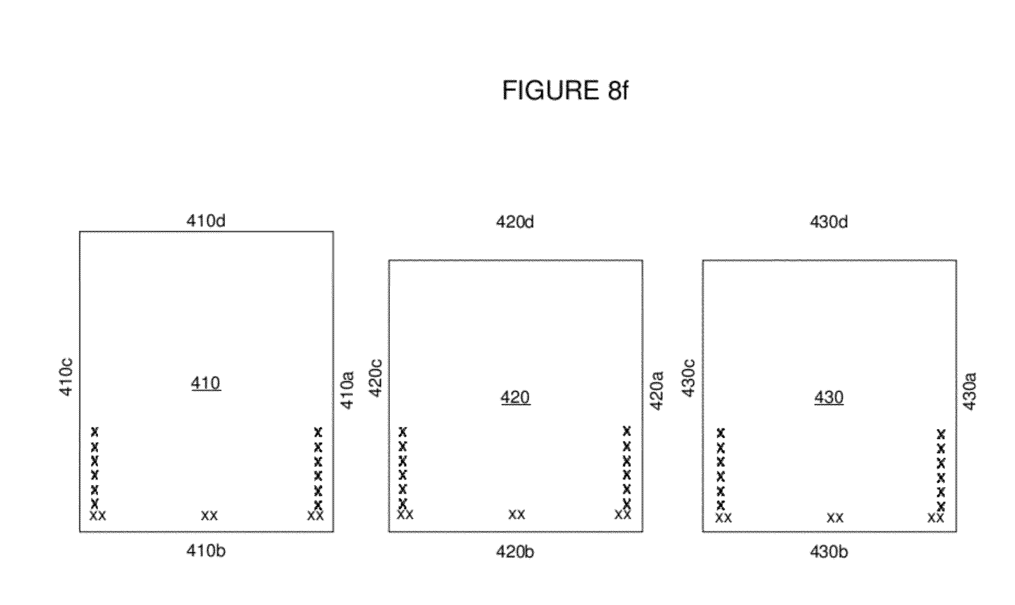

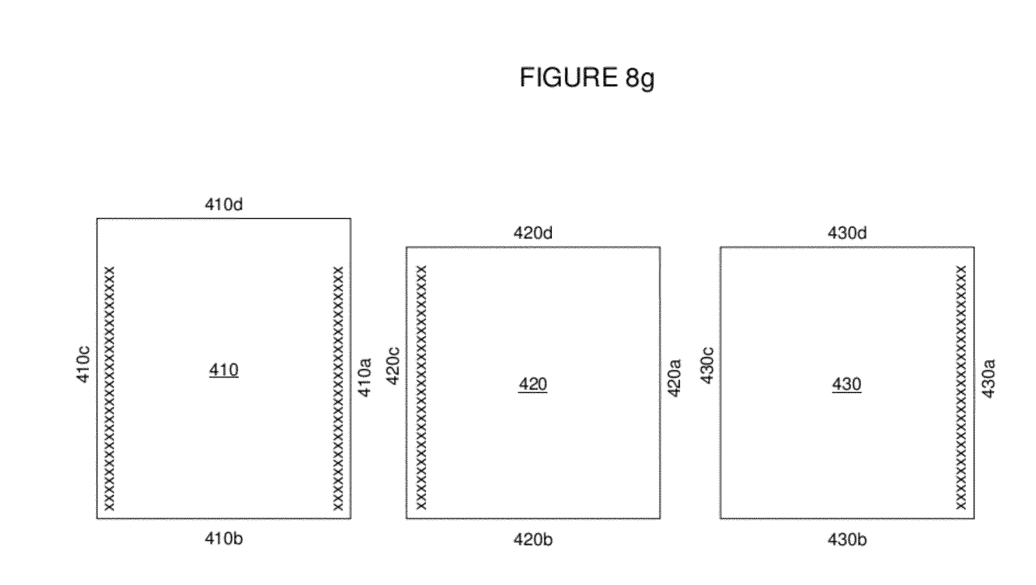

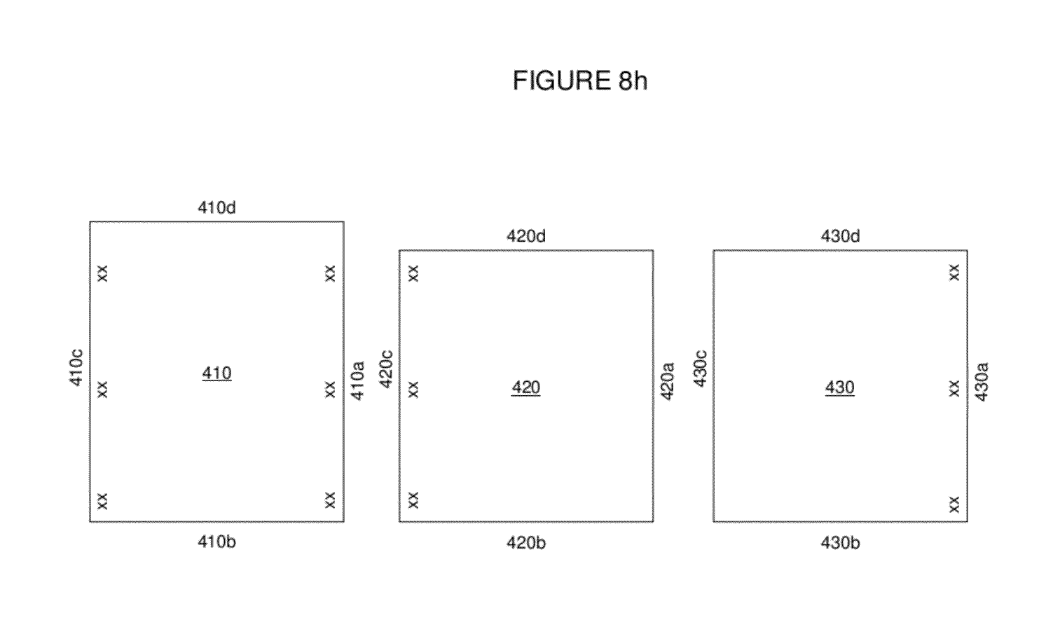

In this embodiment of a blanket constructed as disclosed herein, the attachment area is provided along one of the sides of the blanket 400. In such a case, the panels 410, 420, 430 of blanket 400 may therefore be opened much like a book. FIG. 8a illustrates such an attachment area substantially along all of sides 410a, 420a and 430a of panels 410, 420, 430, respectively. FIG. 8b again illustrates the attachment area of blanket 400 along sides 410a, 420a and 430a of panels 410, 420, 430, respectively, but in this embodiment the attachment means is provided only in the middle and at the ends of these sides 410a, 420a and 430a. However, in FIG. 8c, the attachment area is provided substantially along all of the bottom edges of sides 410b, 420b and 430b of panels 410, 420, 430, respectively. FIG. 8d also illustrates the attachment area of blanket 400 along the bottom edges of sides 410b, 420b and 430b of panels 410, 420, 430, respectively, but in this embodiment the attachment means is provided only in the middle and at the ends of these bottom sides 410b, 420b and 430b of blanket 400. FIG. 8e illustrates the attachment area of blanket 400 along the bottom edges of sides 410b, 420b and 430b of panels 410, 420, 430, respectively, but in this embodiment the attachment means is provided in the middle and at the ends of these bottom sides 410b, 420b and 430b and partially along the edges of 410a, 410c, 420a, 420c, 430a, and 430c of blanket 400. FIG. 8f illustrates the attachment area of blanket 400 substantially along the bottom sides 410b, 420b and 430b of panels 410, 420, 430, respectively, but in this embodiment the attachment means is provided at the ends of these bottom sides 410b, 420b and 430b and partially along the edges of 410a, 410c, 420a, 420c, 430a, and 430c of blanket 400.

FIG. 8g illustrates such an attachment area substantially along all of sides 410a, 410c, 420c and 430a of panels 410, 420, 430, respectively. FIG. 8h again illustrates the attachment area of blanket 400 along sides 410a, 410c, 420c and 430a of panels 410, 420, 430, respectively, but in this embodiment the attachment means is provided only in the middle and at the ends of these sides 410a, 410c, 420c and 430a.

FIGS. 8a, 8b, 8c, and 8d illustrate the individual panels 410, 420, 430 and exemplary area of attachment along one side of each panel. FIGS. 8e and 8f illustrate the individual panels and area of attachment along multiple sides of the panels illustrated therein. FIGS. 8g and 8h illustrate the individual panels and area of attachment along single and multiple sides of the panels illustrated therein. The “X” represents the area of attachment. The area of attachment may be on the top, the bottom, or top and bottom of the panel as determined by the designer or manufacturer. In addition, the attachment of panels together to form the complete blanket may be a combination of these, such along the bottoms of the panels, and then partially or completely up the sides of the panels.

In FIGS. 8a and 8b, a user's feet could be substantially towards sides 410b, 420b, and 430b with the user's head at 410d, 420d, and 430d with the user's side substantially parallel to the area of attachment. If the user preferred not to be in contact with another surface such as the carpet or ground, the user could lie on the panel 410 and cover himself or herself with panels 420 and 430 or any combination thereof. Alternatively, the user may want to cover himself or herself with panels 410, 420, and 430 or any combination thereof if lying on a bed, couch, or another surface preferred by the user. For a baby or toddler, the parent or caretaker may prefer to place the baby or toddler on the panel 410 regardless of the surface (e.g., couch, bed, carpet, or ground). FIG. 8a may provide more insulation and protection to the user than FIG. 8b since there is more area of attachment in 8a than 8b. Alternatively, a user's feet could be substantially towards sides 410d, 420d, and 430d with the user's head at 410b, 420b, and 430b with the user's side substantially parallel to the area of attachment. FIGS. 8a and 8b could allow the user to extend his or her feet beyond the 410b, 420b, and 430b edges or 410d, 420d, and 430d edges since there is no attachment(s) along these edges. This would be a personal preference of the user.

In FIGS. 8c and 8d, a user's feet could be substantially towards sides 410b, 420b, and 430b with the user's head at 410d, 420d, and 430d. If the user preferred not to be in contact with another surface such as the carpet or ground, the user could lie on the panel 410 and cover himself or herself with panels 420 and 430 or any combination thereof. Alternatively, the user may want to cover himself or herself with panels 410, 420, and 430 or any combination thereof if lying on a bed, couch, or another surface preferred by the user. For a baby or toddler, the parent or caretaker may prefer to place the baby or toddler on the panel 410 regardless of the surface (e.g., couch, bed, carpet, or ground). FIG. 8c may provide more insulation and protection to the user than FIG. 8d since there is more area of attachment in 8c than 8d. Since FIGS. 8c and 8d have attachments along 410b, 420b, and 430b, the user may prefer to have his or her feet covered by one or more of the panels.

In FIGS. 8e and 8f, a user's feet could be substantially towards sides 410b, 420b, and 430b with the user's head at 410d, 420d, and 430d. If the user preferred not to be in contact with another surface such as the carpet or ground, the user could lie on panel 410 and cover himself or herself with panels 420 and 430 or any combination thereof. For a baby or toddler, the parent or caretaker may prefer to place the baby or toddler on panel 410 regardless of the surface (e.g., couch, bed, carpet, or ground). When the sides and bottom edges of the panels are attached, it creates a structure like a pocket on a shirt. A parent or caretaker may be interested in this embodiment since it creates a substantially enclosed structure to secure the baby. FIG. 8e may provide more insulation and protection to the user than FIG. 8f since there is more area of attachment in 8e than 8f.

In FIGS. 8g and 8h, a user's feet could be substantially towards sides 410b, 420b, and 430b with the user's head at 410d, 420d, and 430d with the user's side substantially parallel to the area of attachment. If the user preferred not to be in contact with another surface such as the carpet or ground, the user could lie on the panel 410 and cover himself or herself with panels 420 and 430 or any combination thereof. Alternatively, the user may want to cover himself or herself with panels 410, 420, and 430 or any combination thereof if lying on a bed, couch, or another surface preferred by the user. For a baby or toddler, the parent or caretaker may prefer to place the baby or toddler on the panel 410 regardless of the surface (e.g., couch, bed, carpet, or ground). Alternatively, a user's feet could be substantially towards sides 410d, 420d, and 430d with the user's head at 410b, 420b, and 430b with the user's side substantially parallel to the area of attachment. Instead of the panels laying on top on each other, they could be laid substantially flat thereby creating a larger surface area for sleeping or for playing. FIG. 8g may provide more insulation and protection to the user than FIG. 8h since there is more area of attachment in FIGS. 8g than 8h.

The method of attachment could be but is not limited to stitching, zippers, snaps, Velcro®, loops of material, buttons, or ties. The designer or manufacturer may also decide to use several methods of attachment such as buttons on Panel 410, snaps on Panel 420, and Velcro® on Panel 430 or any combination thereof.

In embodiments in which buttons are used to fasten the panels illustrated in FIG. 7, each of the panels may be comprised as follows:
Panel 410 top side: buttons along the attachment edge. The buttons may be inserted through the button hole of Panel 420 and the button hole of Panel 430 and be visible on the top side of Panel 430.
Panel 410 bottom side: buttons may be included for aesthetics only, though not required.
Panel 420: button holes passing completely through Panel 420. (Optionally, buttons could be added along the attachment edge in addition to the button holes. The buttons of Panel 420 may be inserted through the button hole of Panel 430 such that the buttons of Panel 420 would be visible on the top side of Panel 430.)
Panel 430: button holes passing completely through Panel 430.
   The time to fasten or unfasten the various panels will depend on the user and the number of buttons on each panel. Buttons may also need to be re-attached since they could become loose, fall off, or are physically removed by a user such as a baby or toddler. Plus, more buttons per panel could make the blanket more expensive to manufacture. The manufacturer may not want to use buttons if the blanket is intended to be used by a baby or toddler since the buttons could become detached and present a possible choking hazard to the baby or toddler. Of course, the above description of the embodiment illustrated in FIG. 7 is illustrative only, and variations to the above-described approach may also be included in a blanket constructed according to the disclosed principles.

In embodiments in which hook-and-loop fasteners (e.g., Velcro®) are used to fasten the panels illustrated in FIG. 7, each of the panels may be comprised as follows:
Panel 410 top side: hook-and-loop material.
Panel 410 bottom side: hook-and-loop material may be included for aesthetics only, though not required.
Panel 420 top side: hook-and-loop material along the attachment edge although not required in FIGS. 8g and 8h.
Panel 420 bottom side: hook-and-loop material.
Panel 430 top side: nothing along the attachment edge.
Panel 430 bottom side: hook-and-loop material along the attachment edge.
   Velcro® may be less likely to detach from one of the panels as opposed to buttons. Plus, it could be faster and easier for a user to attach or detach panels which use Velcro® as opposed to buttons. However, Velcro® may adhere to other fabrics which could be undesirable by the user and may damage the other fabrics. Of course, the above description of the embodiment illustrated in FIG. 7 is illustrative only, and variations to the above-described approach may also be included in a blanket constructed according to the disclosed principles.

In embodiments in which zippers are used to fasten the panels illustrated in FIG. 7, each of the panels may be comprised as follows:
A single zipper connecting all three Panels 410, 420, 430 together along an attachment edge or side of each; or
A first zipper connecting all Panels 410 and 420 together along their attachment edges, and a second zipper connecting all Panels 420 and 430 together along an attachment edge or side of each. (Optionally, a first zipper connecting all Panels 410 and 420 together along their attachment edges, and a second zipper connecting all Panels 410 and 430 together along an attachment edge or side of each for FIGS. 8g and 8h.)
   As a method of attachment, a zipper could be faster means of adding and removing panels as opposed to other methods such as buttons or snaps. However, a user may need to take special care when using a zipper so that the material of the panel does not get caught in the zipper. Of course, the above description of the embodiment illustrated in FIG. 7 is illustrative only, and variations to the above-described approach may also be included in a blanket constructed according to the disclosed principles.

In embodiments in which stitching is used, all three Panels 410, 420, 430 are stitched together and would not be removably fastened together. In FIGS. 8g and 8h, Panels 410 and 420 are stitched together and would not be removably fastened together, and Panels 410 and 430 are stitched together and would not be removably fastened together. Stitching could be an inexpensive method of attaching the panels with compared to other methods disclosed herein since the manufacturer does not have the added expense of material (e.g., buttons, zippers, Velcro, snaps) and labor and skill required to attach said material.

In embodiments in which snaps are used to fasten the panels illustrated in FIG. 7 (where each snap has a male and female part), each of the panels may be comprised as follows:
Panel 410 top side: male snaps along the attachment edge.
Panel 410 bottom side: female or male snaps may be included for aesthetics only, though not required.
Panel 420 top side: male snaps along the attachment edge although not required in FIGS. 8g and 8h.
Panel 420 bottom side: female snaps along the attachment edge.
Panel 430 top side: female or male snaps may be included for aesthetics only, though not required.
Panel 430 bottom side: female snaps along the attachment edge.
   Like buttons, the time to fasten or unfasten the various panels will depend on the user and the number of snaps on each panel. Snaps may also need to be re-attached since they could become loose, fall off, or are physically removed by a user such as a baby or toddler. Plus, more snaps per panel could make the blanket more expensive to manufacture. The manufacturer may not want to use snaps if the blanket is intended to be used by a baby or toddler since the snaps could become detached and present a possible choking hazard to the baby or toddler. Of course, as with other embodiments, the above description of the embodiment illustrated in FIG. 7 is illustrative only, and variations to the above-described approach may also be included in a blanket constructed according to the disclosed principles.

In embodiments in which loops of material used to fasten the Panels 410, 420, 430, all of the Panels 410, 420, 430 would be removably fastened together. In exemplary embodiments, small incisions may be made in all the Panels 410, 420, 430. The loops of material could then be inserted through the incisions and tied together in a number of different ways, thereby securing all the Panels 410, 420, 430 together. However, loops of material could get lost if they are not properly tied. Plus, loops of material are not secured to the panel like a button, snap, or Velcro® and therefore may have a tendency to get lost. On the other hand, the loops of material could be changed at any time by the user for aesthetic reasons. Of course, this is just one exemplary technique for employing loops of materials to fasten the Panels 410, 420, 430 together, and variations to this approach may also be included in a blanket constructed according to the disclosed principles.

In embodiments in which ties are used to fasten the Panels 410, 420, 430, all of the Panels 410, 420, 430 would again be removably fastened together. In exemplary embodiments, small incisions may be made in Panels 420 and 430, and loops of material sewn or otherwise attached to Panel 410. The loops of material could then be inserted through the incisions in the upper Panels 420, 430, thereby securing all the Panels 410, 420, 430 together. Unlike loops of material not secured to the panels, loops of material sewn or attached to the panels will less likely get lost. However, the user will not have the ease of changing the loops of material that are sewn or attached as opposed to loops of material that are not sewn or attached to the panels. Of course, this is just one exemplary technique for employing ties of materials to fasten the Panels 410, 420, 430 together, and variations to this approach may also be included in a blanket constructed according to the disclosed principles.

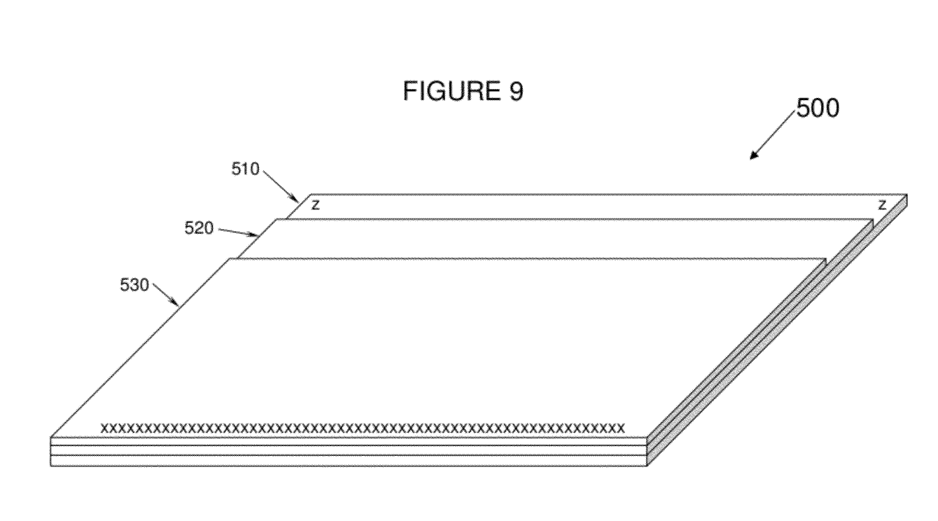

FIG. 9 illustrates an exemplary embodiment for a blanket 500 constructed according to the disclosed principles. Illustrated items of the blanket 500 in FIG. 9 include, in this embodiment, three different panel layers one over another: Panel 510, Panel 520, and Panel 530. Blanket 500 is comprised of panels 510, 520, 530, each of which have different dimensions along their lengths, but have substantially the same dimensions along their widths, as illustrated in FIG. 9. In addition, in this embodiment, panel 510 has four sides (510a, 510b, 510c and 510d), panel 520 has four sides (520a, 520b, 520c and 520d), and panel 530 has four sides (530a, 530b, 530c and 530d). Each of the panels 510, 520, 530 having four sides is merely illustrative, and thus panels have any number of sides, or no sides per se such as with round- or elliptical-shaped blankets, are also envisioned and fall within the scope of the present disclosure. FIG. 11 illustrates one possible cross section for blanket 500.

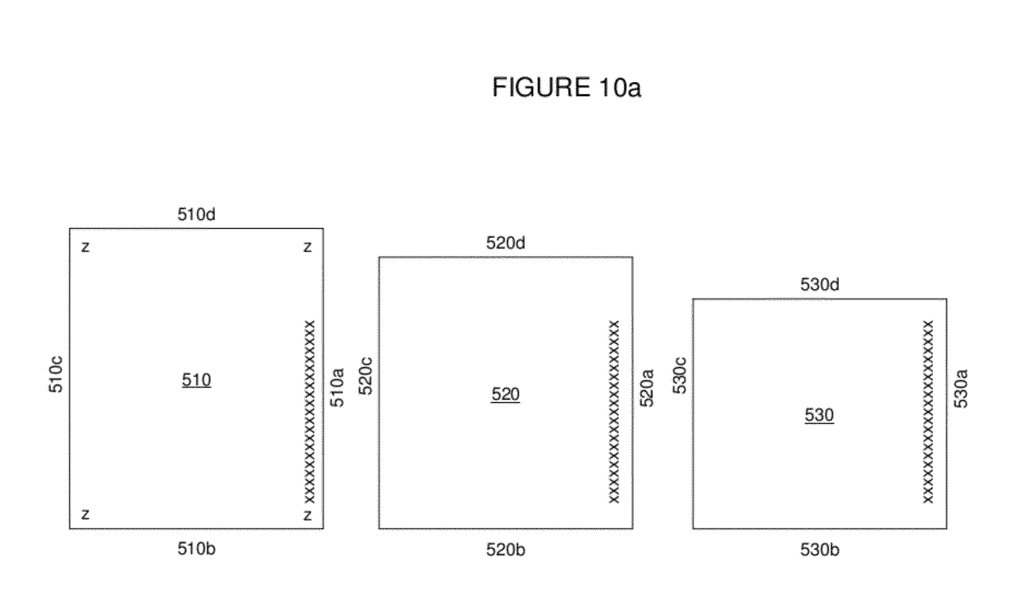

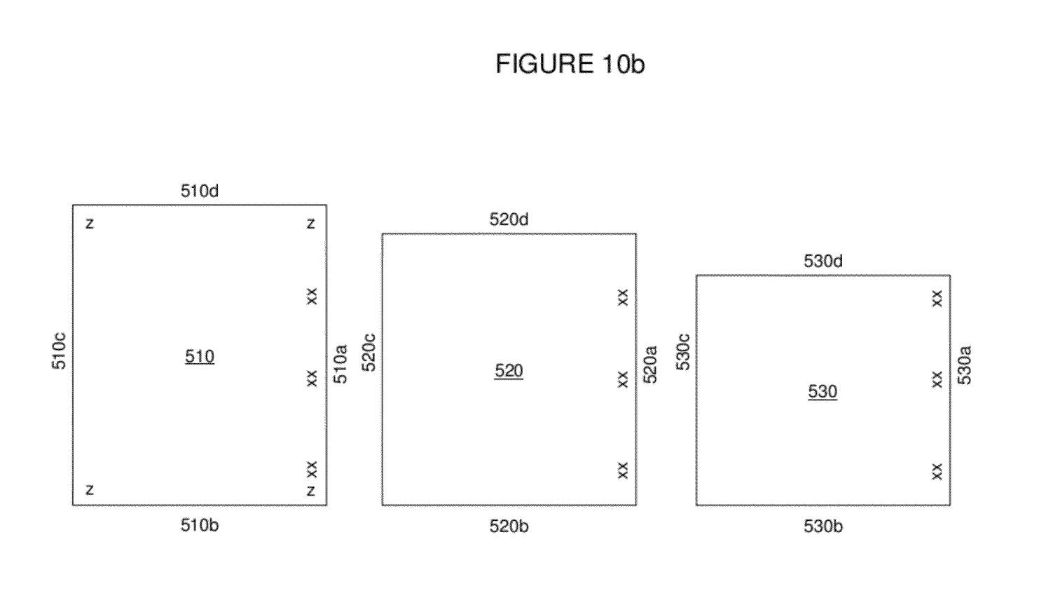

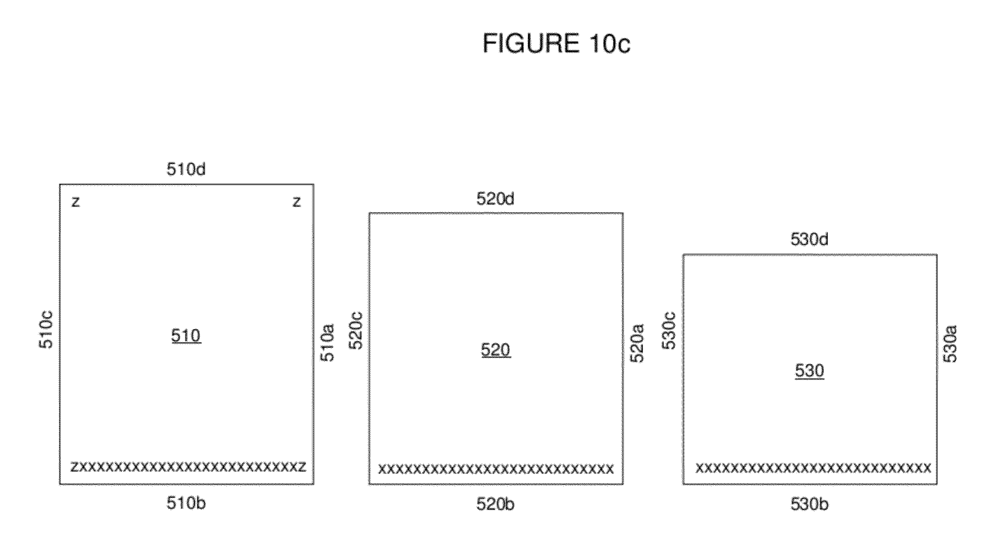

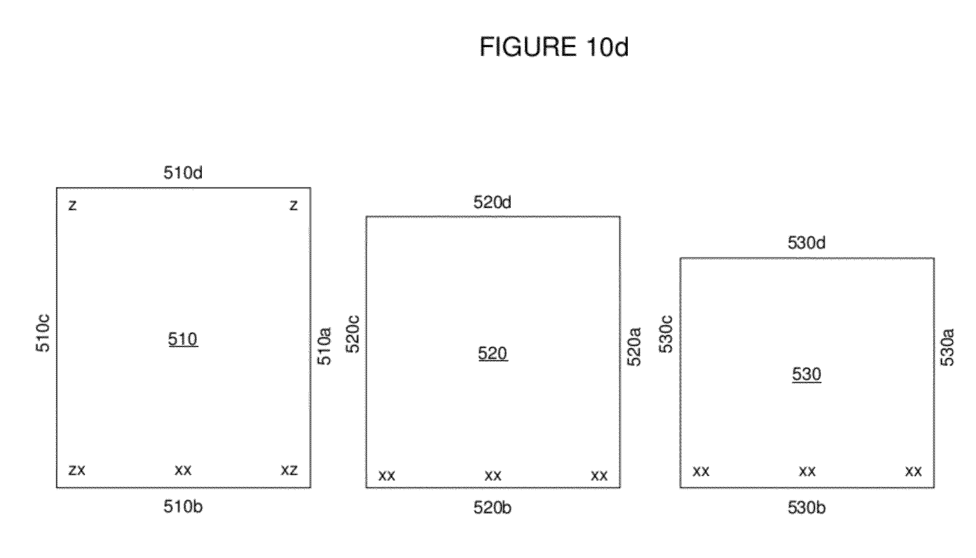

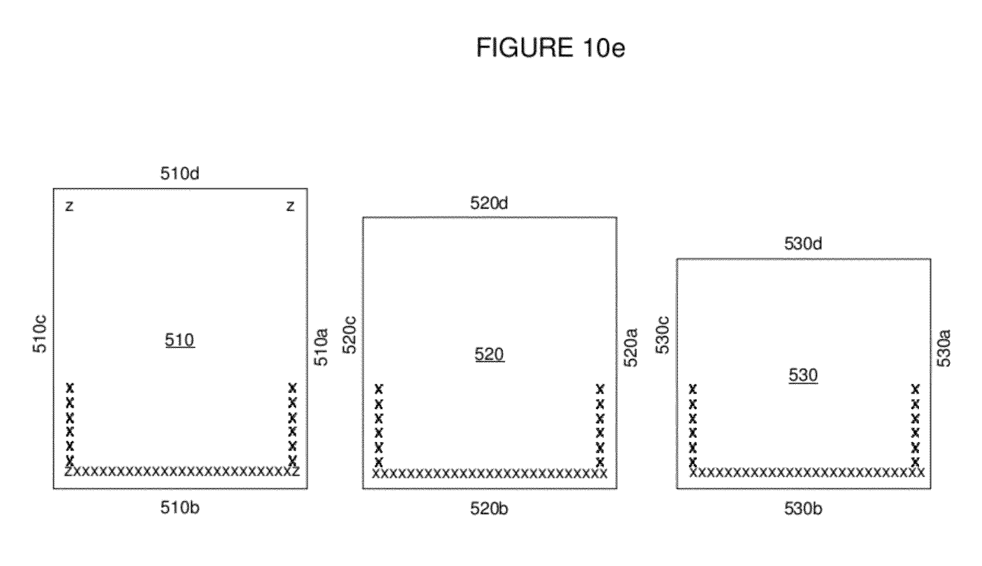

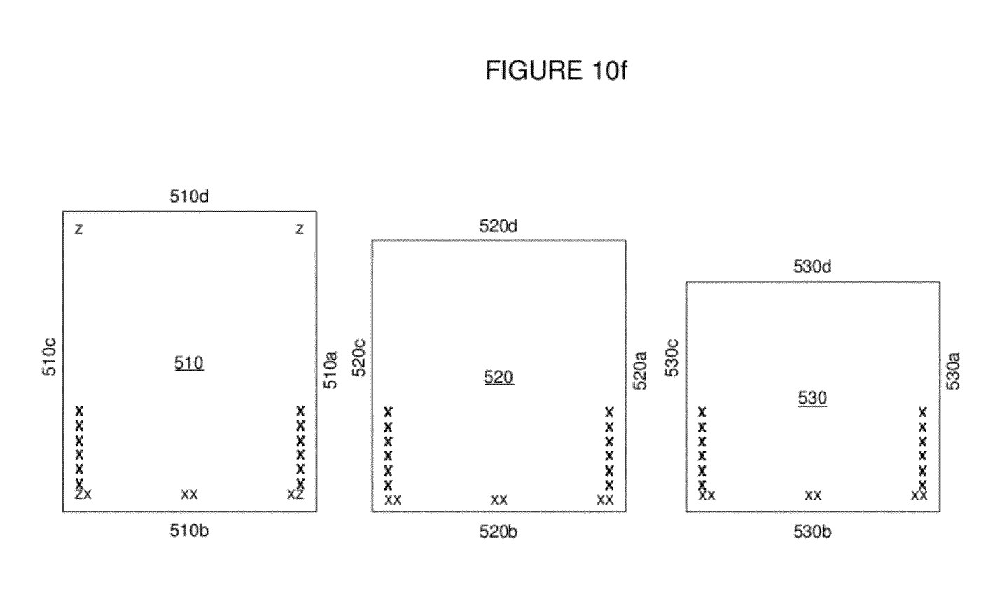

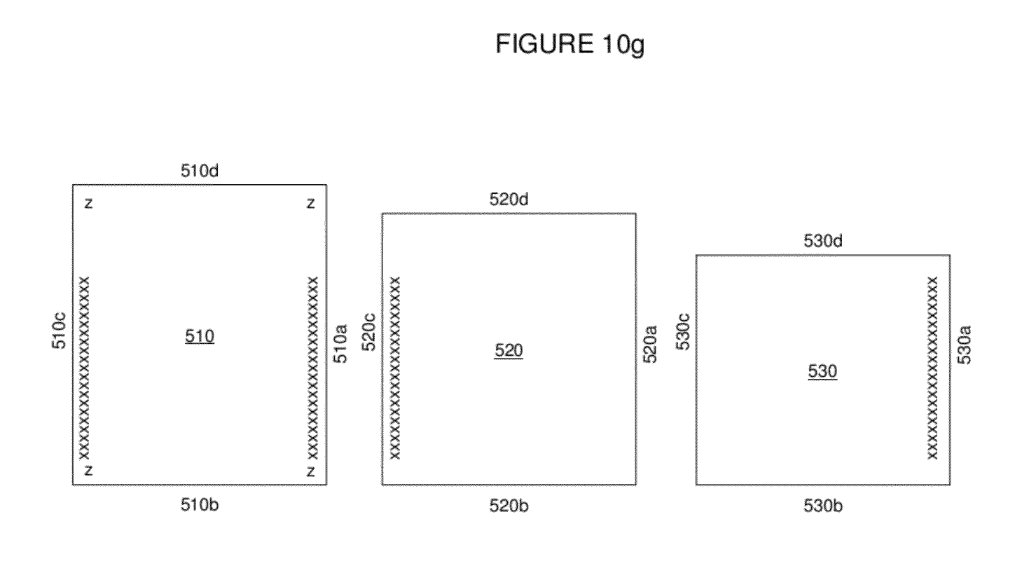

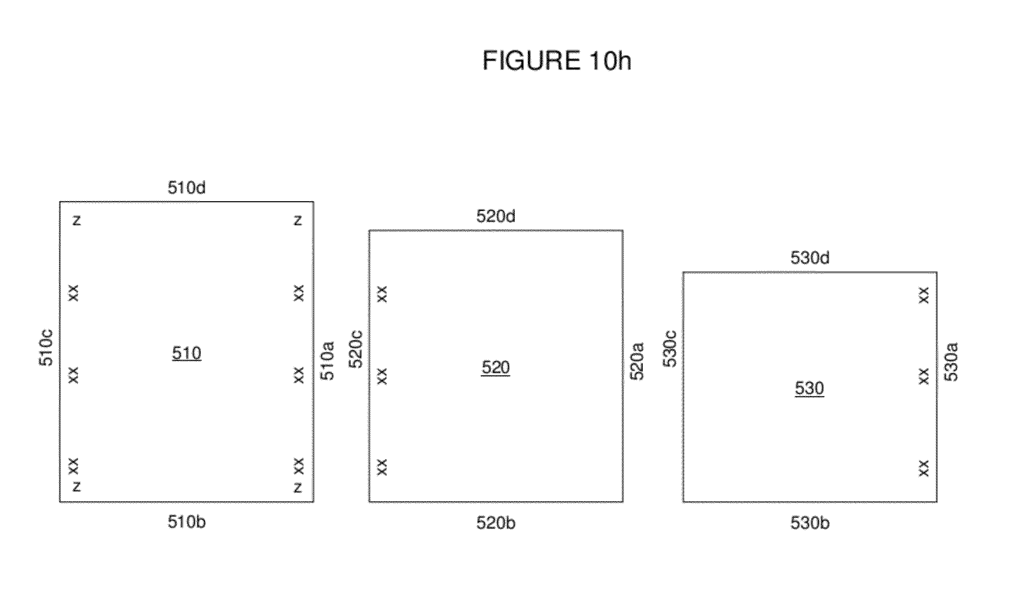

In this embodiment of a blanket constructed as disclosed herein, the attachment area is provided along one of the sides of the blanket 500. In such a case, the panels 510, 520, 530 of blanket 500 may therefore be opened much like a book. FIG. 10a illustrates such an attachment area substantially along all of sides 510a, 520a and 530a of panels 510, 520, 530, respectively. FIG. 10b again illustrates the attachment area of blanket 500 along sides 510a, 520a and 530a of panels 510, 520, 530, respectively, but in this embodiment the attachment means is provided only in the middle and at the ends of these sides 510a, 520a and 530a. However, in FIG. 10c, the attachment area is provided substantially along all of the bottom edges of sides 510b, 520b and 530b of panels 510, 520, 530, respectively. FIG. 10d also illustrates the attachment area of blanket 500 along the bottom edges of sides 510b, 520b and 530b of panels 510, 520, 530, respectively, but in this embodiment the attachment means is provided only in the middle and at the ends of these bottom sides 510b, 520b and 530b of blanket 500. FIG. 10e illustrates the attachment area of blanket 500 along the bottom edges of sides 510b, 520b and 530b of panels 510, 520, 530, respectively, but in this embodiment the attachment means is provided in the middle and at the ends of these bottom sides 510b, 520b and 530b and partially along the edges of 510a, 510c, 520a, 520c, 530a, and 530c of blanket 500. FIG. 10f illustrates the attachment area of blanket 500 substantially along the bottom sides 510b, 520b and 530b of panels 510, 520, 530, respectively, but in this embodiment the attachment means is provided at the ends of these bottom sides 510b, 520b and 530b and partially along the edges of 510a, 510c, 520a, 520c, 530a, and 530c of blanket 500.

FIG. 10g illustrates such an attachment area substantially along all of sides 510a, 510c, 520c and 530a of panels 510, 520, 530, respectively. FIG. 10h again illustrates the attachment area of blanket 500 along sides 510a, 510c, 520c and 530a of panels 510, 520, 530, respectively, but in this embodiment the attachment means is provided only in the middle and at the ends of these sides 510a, 510c, 520c and 530a.

FIGS. 10a, 10b, 10c, and 10d illustrate the individual panels 510, 520, 530 and exemplary area of attachment along one side of each panel. FIGS. 10e and 10f illustrate the individual panels and area of attachment along multiple sides of the panels illustrated therein. FIGS. 10g and 10h illustrate the individual panels and area of attachment along single and multiple sides of the panels illustrated therein. The “Z” of Panel 510 represents an area in which the panel could be fitted to another object such as a crib mattress. The “X” represents the area of attachment. The area of attachment may be on the top, the bottom, or top and bottom of the panel as determined by the designer or manufacturer. In addition, the attachment of panels together to form the complete blanket may be a combination of these, such along the bottoms of the panels, and then partially or completely up the sides of the panels.

In FIGS. 10a and 10b, a user's feet could be substantially towards sides 510b, 520b, and 530b with the user's head at 510d, 520d, and 530d with the user's side substantially parallel to the area of attachment. FIG. 10a may provide more insulation and protection to the user than FIG. 10b since there is more area of attachment in 10a than 10b. Alternatively, a user's feet could be substantially towards sides 510d, 520d, and 530d with the user's head at 510b, 520b, and 530b with the user's side substantially parallel to the area of attachment. FIGS. 10a and 10b could allow the user to extend his or her feet beyond the 510b, 520b, and 530b edges or 510d, 520d, and 530d edges since there is no attachment(s) along these edges. This would be a personal preference of the user.

In FIGS. 10c and 10d, a user's feet could be substantially towards sides 510b, 520b, and 530b with the user's head at 510d, 520d, and 530d. FIG. 10c may provide more insulation and protection to the user than FIG. 10d since there is more area of attachment in 10c than 10d. Since FIGS. 10c and 10d have attachments along 510b, 520b, and 530b, the user may prefer to have his or her feet covered by one or more of the panels.

In FIGS. 10e and 10f, a user's feet could be substantially towards sides 510b, 520b, and 530b with the user's head at 510d, 520d, and 530d. When the sides and bottom edges of the panels are attached, it creates a structure like a pocket on a shirt. A parent or caretaker may be interested in this embodiment since it creates a substantially enclosed structure to secure the baby. FIG. 10e may provide more insulation and protection to the user than FIG. 8f since there is more area of attachment in 10e than 10f.

In FIGS. 10g and 10h, a user's feet could be substantially towards sides 510b, 520b, and 530b with the user's head at 510d, 520d, and 530d with the user's side substantially parallel to the area of attachment. Alternatively, a user's feet could be substantially towards sides 510d, 520d, and 530d with the user's head at 510b, 520b, and 530b with the user's side substantially parallel to the area of attachment. Instead of the panels laying on top on each other, they could be laid substantially flat thereby creating a larger surface area for sleeping or for playing. FIG. 10g may provide more insulation and protection to the user than FIG. 10h since there is more area of attachment in FIGS. 10g than 10h.

The method of attachment could be but is not limited to stitching, zippers, snaps, Velcro®, loops of material, buttons, or ties. The designer or manufacturer may also decide to use several methods of attachment such as buttons on Panel 510, snaps on Panel 520, and Velcro® on Panel 530 or any combination thereof.

In embodiments in which buttons are used to fasten the panels illustrated in FIG. 9, each of the panels may be comprised as follows:
Panel 510 top side: buttons along the attachment edge. The buttons may be inserted through the button hole of Panel 520 and the button hole of Panel 530 and be visible on the top side of Panel 530.
Panel 510 bottom side: buttons may be included for aesthetics only, though not required.
Panel 520: button holes passing completely through Panel 520. (Optionally, buttons could be added along the attachment edge in addition to the button holes. The buttons of Panel 520 may be inserted through the button hole of Panel 530 such that the buttons of Panel 520 would be visible on the top side of Panel 530.)
Panel 530: button holes passing completely through Panel 530.
   The time to fasten or unfasten the various panels will depend on the user and the number of buttons on each panel. Buttons may also need to be re-attached since they could become loose, fall off, or are physically removed by a user such as a baby or toddler. Plus, more buttons per panel could make the blanket more expensive to manufacture. The manufacturer may not want to use buttons if the blanket is intended to be used by a baby or toddler since the buttons could become detached and present a possible choking hazard to the baby or toddler. Of course, the above description of the embodiment illustrated in FIG. 9 is illustrative only, and variations to the above-described approach may also be included in a blanket constructed according to the disclosed principles.

In embodiments in which hook-and-loop fasteners (e.g., Velcro®) are used to fasten the panels illustrated in FIG. 9, each of the panels may be comprised as follows:
Panel 510 top side: hook-and-loop material.
Panel 510 bottom side: nothing along the attachment edge.
Panel 520 top side: hook-and-loop material along the attachment edge although not required in FIGS. 10g and 10h.
Panel 520 bottom side: hook-and-loop material.
Panel 530 top side: nothing along the attachment edge.
Panel 530 bottom side: hook-and-loop material along the attachment edge.
   Velcro® may be less likely to detach from one of the panels as opposed to buttons. Plus, it could be faster and easier for a user to attach or detach panels which use Velcro® as opposed to buttons. However, Velcro® may adhere to other fabrics which could be undesirable by the user and may damage the other fabrics. Of course, as before, the above description of the embodiment illustrated in FIG. 9 is illustrative only, and variations to the above-described approach may also be included in a blanket constructed according to the disclosed principles.

In embodiments in which zippers are used to fasten the panels illustrated in FIG. 9, each of the panels may be comprised as follows:
A single zipper connecting all three Panels 510, 520, 530 together along an attachment edge or side of each; or
A first zipper connecting all Panels 510 and 520 together along their attachment edges, and a second zipper connecting all Panels 520 and 530 together along an attachment edge or side of each. (Optionally, a first zipper connecting all Panels 510 and 520 together along their attachment edges, and a second zipper connecting all Panels 510 and 530 together along an attachment edge or side of each for FIGS. 10g and 10h.)
   As a method of attachment, a zipper could be faster means of adding and removing panels as opposed to other methods such as buttons or snaps. However, a user may need to take special care when using a zipper so that the material of the panel does not get caught in the zipper. Of course, the above description of the embodiment illustrated in FIG. 9 is illustrative only, and variations to the above-described approach may also be included in a blanket constructed according to the disclosed principles.

In embodiments in which stitching is used, all three Panels 510, 520, 530 are stitched together and would not be removably fastened together. In FIGS. 10g and 10h, Panels 510 and 520 are stitched together and would not be removably fastened together, and Panels 510 and 530 are stitched together and would not be removably fastened together. Stitching could be an inexpensive method of attaching the panels with compared to other methods disclosed herein since the manufacturer does not have the added expense of material (e.g., buttons, zippers, Velcro, snaps) and labor and skill required to attach said material.

In embodiments in which snaps are used to fasten the panels illustrated in FIG. 9 (where each snap has a male and female part), each of the panels may be comprised as follows:
Panel 510 top side: male snaps along the attachment edge although not required in FIGS. 10g and 10h.
Panel 510 bottom side: female or male snaps may be included for aesthetics only, though not required.
Panel 520 top side: male snaps along the attachment edge.
Panel 520 bottom side: female snaps along the attachment edge.
Panel 530 top side: female or male snaps may be included for aesthetics only, though not required.
Panel 530 bottom side: female snaps along the attachment edge.
   Like buttons, the time to fasten or unfasten the various panels will depend on the user and the number of snaps on each panel. Snaps may also need to be re-attached since they could become loose, fall off, or are physically removed by a user such as a baby or toddler. Plus, more snaps per panel could make the blanket more expensive to manufacture. The manufacturer may not want to use snaps if the blanket is intended to be used by a baby or toddler since the snaps could become detached and present a possible choking hazard to the baby or toddler. Of course, the above description of the embodiment illustrated in FIG. 9 is illustrative only, and variations to the above-described approach may also be included in a blanket constructed according to the disclosed principles.

In embodiments in which loops of material used to fasten the Panels 510, 520, 530, all of the Panels 510, 520, 530 would be removably fastened together. In exemplary embodiments, small incisions may be made in all the Panels 510, 520, 530. The loops of material could then be inserted through the incisions and tied together in a number of different ways, thereby securing all the Panels 510, 520, 530 together. However, loops of material could get lost if they are not properly tied. Plus, loops of material are not secured to the panel like a button, snap, or Velcro® and therefore may have a tendency to get lost. On the other hand, the loops of material could be changed at any time by the user for aesthetic reasons. Of course, this is just one exemplary technique for employing loops of materials to fasten the Panels 510, 520, 530 together, and variations to this approach may also be included in a blanket constructed according to the disclosed principles.

In embodiments in which ties are used to fasten the Panels 510, 520, 530, all of the Panels 510, 520, 530 would again be removably fastened together. In exemplary embodiments, small incisions may be made in Panels 520 and 530, and loops of material sewn or otherwise attached to Panel 510. The loops of material could then be inserted through the incisions in the upper Panels 520, 530, thereby securing all the Panels 510, 520, 530 together. Unlike loops of material not secured to the panels, loops of material sewn or attached to the panels will less likely get lost. However, the user will not have the ease of changing the loops of material that are sewn or attached as opposed to loops of material that are not sewn or attached to the panels. Of course, this is just one exemplary technique for employing ties of materials to fasten the Panels 510, 520, 530 together, and variations to this approach may also be included in a blanket constructed according to the disclosed principles.

The physical dimensions of the panels and method of attachment are for illustrative purposes only. The embodiments in this application illustrate 4-sided polygon panels. One may also choose to use other multi-sided polygon, elliptical, or circular panels. The method of attaching the panels and area of attachment can be determined by the designer or manufacturer. The panels should be attached on at least one side. The side and or sides for attaching the panels can be determined by the designer or manufacturer. Although we have shown three panels in our illustrations, the blanket should be comprised of at least two or more panels. The material, dimensions, spacing, and properties of the attachments (e.g. wood buttons, plastic buttons, metal buttons, plastic zipper, metal zipper, hook-and-loop, loop length, loop material, thread, stitch type, stitch length) can be determined by the designer or manufacturer. The insulating and or physical properties of the panels (e.g. ring spun cotton, open end cotton, pima cotton, cashmere, wool, Merino wool, alpaca, satin, fleece, furs, faux furs, polyester, acrylic) may vary and can be determined by the designer or manufacturer.

Each panel of blanket 100, 200, 300, 400, and 500 may be comprised of different materials or thicknesses. For example, the base panel (110, 210, 310, 410, and 510) may be comprised of a padded or thicker material (e.g. foam layer in between two cotton layers) such that the user can lie on top of this panel. The base layer could act as a barrier between the user and the underlying surface or may simply provide more comfort to the user. Alternatively, the user may choose to cover himself or herself with the base panel instead of lying on it. The middle panel (120, 220, 320, 420, and 520) may be comprised of cotton. The top panel (130, 230, 330, 430, and 530) may be comprised of wool. Of course, other variations and/or combinations of materials may be used for the panels in a blanket constructed according to the disclosed principles.

Based on the exemplary embodiments described above, blankets constructed according to the disclosed principles are superior to conventionally constructed blankets. For example, in U.S. Pat. No. 3,508,285, Marquette claims blankets with multiple panels that have different warmth characteristics. However, Marquette's blanket is designed for a double bed in which half panels with different warmth characteristics are attached together along their long edges to form one blanket that can be shared by two users. In stark contrast, the principles of the blanket can vary in both materials and dimensions and is not limited to just beds. Furthermore, Marquette's blanket is sized for use by two occupants in the bed, whereas the disclosed blanket is layered such that in can be used by a single user, such as an infant, baby, or child, and is certainly not limited to a single or double bed. A parent/caretaker may also use the disclosed blanket to cover the baby when carrying the baby. In sum, Marquette's blanket requires two half panels to construct the overall area of the blanket. In contrast, the disclosed blanket is not limited to the specific number of two panels, and instead may often be constructed of more than two panels. Moreover, each panel of the disclosed blanket is typically the overall width of the complete blanket, rather than having to be attached together along the panel edges to reach the width of the blanket.

Additionally, in U.S. Pat. No. 4,573,227, Prandina discloses a blanket assembly intended for single and double bed applications in which buttons and buttonholes are used to attach the blankets. The presently disclosed blanket is not limited to single, double, or any bed for that matter, and is not limited in using buttons as a method of attachment. Prandina claims that the blanket assembly must be comprised of at least two rectangular single bed blankets. The dimensions of the disclosed blanket are instead determined by the designer or manufacturer, and certainly need not be just rectangular. Also, in addition to buttons, our blanket could use but is not limited to stitching, zippers, snaps, or even hook-and-loop as other means of attachment of the blanket panels. Furthermore, just like Marquette's blanket, Prandina's blanket requires two half panels, joined along their long edges, to provide the overall size or area of the blanket. In contrast, the disclosed blanket has panels that are each typically the overall size or width of the complete blanket, rather than having to be attached together along the panel edges to reach the width of the blanket.

In sum, both of the above-discussed conventional multiple panel blankets are composed of panels that each provide only a portion of the overall size or width of the overall completed blanket. In contrast, a blanket constructed according to the disclosed principles includes panels that each provide substantially all of the overall size or width of the completed blanket. Accordingly, since the long edges of these conventional blankets are connected to provide the overall coverage of the blanket, the connection of their panels runs up the middle of each blanket. Not only does such placement of the connection seam cause potential for snagging a user's digits of clothes, but also the resulting blanket is unsightly because of such a seam. Moreover, the insulating properties of these conventional blankets do not result in uniform insulating properties across the width of the blanket. In contrast, a blanket constructed according to the disclosed principles does not have the unsightly connection seam of the prior art blankets, and has uniform insulating properties substantially across its size or width since the multiple panels are layers rather than connected edge to edge.

A multiple panel blanket constructed in accordance with the disclosed principles allows a cover up with one or more panels, depending on the level of insulation he or she desires. Heating elements may be added to any panel change the thermal properties of the panel and thus the overall blanket although not required. A base layer could be constructed of a material with a thickness that would emulate a padded mattress cover. The middle layer could be constructed of a thinner material that would emulate a sheet. The top layer could be constructed of a thicker material that would emulate a thermal blanket or bed comforter. Unlike conventional bedding comprised of separate layers (e.g. fitted sheet and/or mattress pad, a sheet, and a thermal blanket and/or comforter), a multiple panel blanket has multiple panels which can be added or removed depending on the user. A multiple panel blanket attached along one or more edges prevents the various layers from being separated unless desired by the user. With conventional bedding, the fitted sheet, mattress pad, sheet, thermal blanket, and comforter are separate layers and not attached to one another. If panels are not attached, they could unintentionally fall off portions or all of the user's body, thereby affecting the warmth/comfort of the user without the user knowing.

A multiple panel blanket constructed in accordance with the disclosed principles may also be constructed of the same material with the same insulating properties. Heating elements may be added to any panel change the thermal properties of the panel and thus the overall blanket although not required. As the user covers himself or herself with more layers, the level of insulation level thereby could also increase.

A multiple panel blanket constructed in accordance with the disclosed principles and having a bottom layer that can be fitted to another surface, such as a mattress, can also be more cost effective. Heating elements may be added to any panel change the thermal properties of the panel and thus the overall blanket although not required. The parent or caretaker need only purchase the multiple panel blanket instead of a fitted sheet and a sheet and/or thermal blanket. The baby or toddler can lie on the base layer, and the parent or caretaker cover him or her with the other layers depending on the level of comfort and insulation that is desired. With the multiple panel blanket disclosed herein attached along one or more edges, the parent or caretaker need not worry about the layers becoming separated unless the parent or caretaker chooses to remove the panels at the area of attachment. Thus, a blanket as disclosed herein can provide extra safety for infants, where unattached blankets often get pulled up to the infant's face, which may potential result in a breathing hazard. Moreover, in some embodiments of the disclosed blankets, additional ties of material may be secured to the bottom edge(s) of the blanket, which can then be used to secure the bottom of the disclosed blanket to an object such as footboard or the bars of the crib by the user's feet.

Some embodiments of the multiple panel blankets describe attachments along more than one side, which can form a pocket like structure. A typical sleeping bag also forms a pocket like structure. However, in contrast to the multiple panel blanket disclosed herein with attachments substantially or partially along more than one side, a typical sleeping bag is constructed with one panel that is folded in half over itself and attached along the bottom edge and substantially along one side with a continuous method of attachment. A sleeping bag uses one single method of attachment to form a pocket whereas the multiple panel blanket can have a combination of several methods of attachment to form a pocket. As stated earlier, a multiple panel blanket constructed in accordance with the disclosed principles need not be limited to one method of attachment (e.g., all buttons or all zippers). For the disclosed multiple panel blanket, a combination of several methods of attachment (e.g., buttons and stitching or zippers and snaps) could be used to attach the panels. For example, a zipper or stitching could be used along the bottom edges to secure all the panels together. Other fasteners such as buttons or snaps could be placed partially or completely along the long sides of the panels. When the user such as an infant or toddler is lying on the base layer, the parent or caretaker could cover the user with the other layer or layers and use some or all of the buttons or snaps along the edges of those layers to secure the infant or toddler who is lying within the blanket. The parent or caretaker may also choose to remove one or more layers depending on the needs of the infant or toddler. The examples described herein need not be limited to zippers, stitching, snaps, or buttons and may be any method or methods of attachment for a multiple panel blanket with attachments along the more than one side as determined by the designer and/or manufacturer.

While various embodiments of the principles disclosed herein have been described above, it should be understood that they have been presented by way of example only, and not limitation. For example, although certain materials are mentioned by example, other materials may also be used. Persons of ordinary skill in this art may implement the disclosed principles by varying one or more of the characteristics of the disclosed principles described above, without departing from the spirit and scope of the present disclosure. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A multiple panel blanket, comprising:
a base panel;
at least one upper panel located on the base panel, and having at least one of a length or a width coextensive with a corresponding length or width of the base panel; and
wherein the at least one upper panel is fastened to the base panel along at least a portion of corresponding sides of the base panel and the at least one upper panel that provide the coextensive length or width.

2. A multiple panel blanket according to claim 1, wherein the at least one upper panel is removably fastened to the base panel proximate to an edge of the corresponding sides using one or more removable fasteners selected from the group consisting of buttons, snaps, hook-and-loop, loops of material, ties of material, and a zipper.

3. A multiple panel blanket according to claim 2, wherein the at least one upper panel comprises a middle panel located on the base panel and a top panel located on the middle panel, the middle and top panels having at least a length or width coextensive with one another, and wherein the top panel is removably fastened to the middle panel, and the middle panel is removably fastened to the base panel, each using distinct removable fasteners.

4. A multiple panel blanket according to claim 1, wherein the at least one upper panel is non-removably fastened to the base panel.

5. A multiple panel blanket according to claim 1, wherein the base panel is padded and adapted to be laid upon.

6. A multiple panel blanket according to claim 1, wherein the at least one upper panel comprises two or more upper panels stacked on the base panel, and wherein the two or more upper panels have coextensive lengths and widths with one another, and only a coextensive length or width with the base panel.

7. A multiple panel blanket according to claim 1, wherein the at least one upper panel comprises two or more upper panels stacked on the base panel, and wherein one of the two or more upper panels has only a coextensive length or width with others of the two or more upper panels, and the coextensive length or width of the two or more upper panels is coextensive with a length or width with the base panel.

8. A multiple panel blanket according to claim 1, wherein the at least one upper panel is further fastened to the base panel along at least a portion of corresponding opposing sides of the base panel and the at least one upper panel that are adjacent to the initially fastened corresponding sides of the base panel and the at least one upper panel.

9. A multiple panel blanket according to claim 1, wherein the at least one upper panel and the base panel comprise rectilinear shapes.

10. A multiple panel blanket according to claim 1, wherein the at least one upper panel and the base panel comprise one or more materials selected from the group consisting of ring spun cotton, open end cotton, pima cotton, cashmere, wool, Merino wool, alpaca, satin, fleece, fur, faux fur, polyester, and acrylic.

11. A multiple panel blanket, comprising:
a base panel;
two or more upper panels stacked on the base panel, wherein at least one of a length or a width of one upper panel is coextensive with a corresponding length or width of others of the two or more upper panels, and wherein the base panel has at least one of a length or width coextensive with the corresponding coextensive length or width of the upper panels; and
wherein the two or more upper panels are fastened to the base panel along at least a portion of corresponding sides of the base panel and the two or more upper panels that provide the coextensive length or width.

12. A multiple panel blanket according to claim 11, wherein the at least one upper panel is removably fastened to the base panel proximate to an edge of the corresponding sides using one or more removable fasteners selected from the group consisting of buttons, snaps, hook-and-loop, loops of material, ties of material, and a zipper.

13. A multiple panel blanket according to claim 11, wherein the two or more upper panels are non-removably fastened to the base panel.

14. A multiple panel blanket according to claim 11, wherein the two or more upper panels are further fastened to the base panel along at least a portion of corresponding opposing sides of the base panel and the two or more upper panels that are adjacent to the initially fastened corresponding sides of the base panel and the two or more upper panels.

15. A multiple panel blanket according to claim 11, wherein the two or more upper panels and the base panel comprise rectilinear shapes.

16. A multiple panel blanket according to claim 11, wherein the two or more upper panels and the base panel comprise one or more materials selected from the group consisting of ring spun cotton, open end cotton, pima cotton, cashmere, wool, Merino wool, alpaca, satin, fleece, fur, faux fur, polyester, and acrylic.

17. A method of constructing a multiple panel blanket, the method comprising:
providing a base panel;
locating at least one upper panel on the base panel, the at least one upper panel having at least one of a length or a width coextensive with a corresponding length or width of the base panel; and
fastening the at least one upper panel to the base panel along at least a portion of corresponding sides of the base panel and the at least one upper panel that provide the coextensive length or width.

18. A method according to claim 17, wherein the fastening comprises removably fastening the at least one upper panel to the base panel proximate to an edge of the corresponding sides using one or more removable fasteners selected from the group consisting of buttons, snaps, hook-and-loop, loops of material, ties of material, and a zipper.

19. A method according to claim 17, wherein the fastening comprises non-removably fastening the at least one upper panel to the base panel.

20. A method according to claim 17, wherein the fastening further comprises fastening the at least one upper panel to the base panel along at least a portion of corresponding opposing sides of the base panel and the at least one upper panel that are adjacent to the initially fastened corresponding sides of the base panel and the at least one upper panel.
